(19) United States
(12) Patent Application Publication
(10) Pub. No.: US 2002/0064482 A1
(43) Pub. Date: May 30, 2002

(54) Method and apparatus for developing DNA microarrays

(76) Inventors: Thomas C. Tisone, Orange, CA (US); Donald J. Rose JR., Chapel Hill, NC (US); Michael K. Cabourne, Fullerton, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/776,173

(22) Filed: Feb. 2, 2001

Related U.S. Application Data
(60) Provisional application No. 60/179,650, filed on Feb. 2, 2000.

(51) Int. Cl. B01L 3/02; B01J 19/00

(52) U.S. Cl. 422/100; 436/174; 436/43; 436/180; 422/99; 422/104; 422/131

(57) ABSTRACT

The invention relates to methods and systems for high throughput and quantitative processing, assaying and development of microarrays of DNA, proteins and other biological and chemical reagents. An in-line processing system can be utilized based on a continuous indexing of microarray slides or substrates through a series of processes where different functions or processes are performed at different positions on a conveyor. A batch processing system can also be utilized, wherein the process steps are performed serially to an array of microarray slides or substrates mounted on a movable table or carriage. A versatile positive displacement aerosol dispensing system has the ability to aspirate fluid. A universal substrate cassette can hold a plurality of substrates or slides through a number of process steps without the need to remove the substrates or slides from the cassette.

### RELATED APPLICATIONS

This application claims the benefit of U.S. Provisional Patent Application No. 60/179,650, filed Feb. 2, 2000, the entire disclosure of which is hereby incorporated by reference herein.

### BACKGROUND OF THE INVENTION

1. Field of the Invention

The present invention relates generally to methods and machines for developing reagent microarrays, and in particular to a method and apparatus for high throughput and quantitative development, assaying and processing of DNA microarrays and other high density chemical and biological microarrays on a solid or porous surface.

2. Description of the Related Art

The nuclei of living cells possess chromosomes which contain the genetic information necessary for the growth, regeneration and other functioning of organisms. Instructions concerning such functioning are contained in the molecules of deoxyribonucleic acid (DNA). DNA is contained within the chromosome in a form of complimentary strands commonly thought of as being configured in a double helix.

Genetic information in DNA is contained within a sequence of nucleotide bases. The four bases consist of thymine (T), adenine (A), cytosine (C), and guanine (G). The two strands of the DNA double helix are joined in accordance with well known base pairing rules. These rules provide that T joins with A and that C joins with G. Accordingly, the base sequence along one strand determines the order of bases along the complementary strand.

Genetic and diagnostic information can be gathered by determining the sequence of bases in DNA strands. In genomics, which is the study of genes and their DNA, one such process utilizes a microarray of single strands of known DNA formed on a glass slide or other substrate. Typically, an unknown sample of DNA is broken into pieces and tagged with a fluorescent molecule. The unknown DNA sample is applied to the microarray; each piece binds or hybridizes only to its matching known DNA “zipper” on the microarray as determined by the base pairing rules. The perfect matches shine the brightest when the fluorescent DNA binds to them. Usually, a laser is used to scan the microarray for bright, perfect matches and a computer ascertains or assembles the DNA sequence of the unknown simple.

The microarrays can be used to read a particular human's genetic blueprint. The arrays decode the genetic differences that make one person chubbier, happier or more likely to get heart disease than another. Such arrays could detect mutations, or changes in an individual's chemical or genetic make-up, that might reveal something about a disease or a treatment strategy.

Proteomics is the study of the way proteins work inside cells, and how they interact with each other. Since cells make their proteins according to the DNA templates in genes, proteomics is a field that is linked to genomics. One aim is to work out the differences in protein action between diseased cells and healthy ones. Binding between proteins in such cells is analyzed to try to determine markers or indicators when disease strikes and to diagnose disorders.

Conventional technologies and processes used in and/or associated with the hybridization and/or assaying of DNA, proteins and other chemical or biological microarrays require many steps and take considerable time. This reduces process efficiency and can also add to the cost. Moreover, these processes involve the use of microfluidic or sub-microliter quantities of liquids or reagents and it can be a difficult task to precisely handle, transfer and deliver such quantities.

### SUMMARY OF THE INVENTION

The present invention overcomes some or all of the above limitations by providing methods and systems for high throughput and quantitative processing, assaying and development of microarrays of DNA, proteins and other biological and chemical reagents. In one preferred embodiment, an in-line processing approach is utilized based on a continuous indexing of microarray slides or substrates through a series of processes where different functions or processes are performed at different positions on a conveyor. In another preferred embodiment, a batch process approach is utilized, wherein the process steps are performed serially to an array of microarray slides or substrates mounted on a movable table or carriage. In yet another preferred embodiment, the present invention provides a versatile positive displacement aerosol dispensing system which has the ability to aspirate fluid and dispense it in a spray pattern. Advantageously, the aerosol system can be used to perform several functions during the processing of microarrays, among other functions. These include, but are not limited to, dispensing and/or aspirating of probe reagents, blocking reagents and washing reagents and drying. In a further preferred embodiment, a universal substrate cassette is provided for holding a plurality of substrates or slides through a number of process steps without the need to remove the substrates or slides from the cassette.

In accordance with one preferred embodiment, the invention provides a method of high throughput and quantitative processing of microarrays of biological or chemical material on substrates. The method comprises the steps of simultaneously transporting a plurality of the substrates at a predetermined speed on a movable surface. At least one tagged reagent is dispensed onto the substrates in the form of an aerosol mist. The substrates are incubated under conditions that promote reaction between the tagged reagent(s) and the biological or chemical material while the substrates are on the movable surface.

In accordance with another preferred embodiment, the invention provides an apparatus for in-line processing of high density microarrays of DNA material on a plurality of substrates. The apparatus generally comprises a conveyor, a plurality of workstations, a fluid transfer device and a heating system. The conveyor provides continuous indexing motion to the substrates while a series of assaying processes are performed at predetermined positions along the conveyor. Each workstation is adapted to perform at least one of the assaying processes. The fluid transfer device is positioned at a predetermined position along the conveyor and generally comprises a dispenser and a positive displacement pump. The dispenser is mounted on a motion head and is adapted to aspirate programmable volumetric amounts of reagents from a source and to dispense programmable volumetric amounts of the reagents in the form of a spray on the substrates to uniformly coat the substrates. The positive displacement pump is serially connected to the dispenser for metering the aspiration and dispensing of the reagents. The heating system is positioned at a predetermined position along the conveyor and downstream of the fluid transfer device for incubating the substrates as they are transported on the conveyor.

In accordance with yet another preferred embodiment, the invention provides a system for the batch processing of arrays of biological or chemical material, comprising. The system generally comprises a plurality of substrates, a motion platform and a dispenser. Each substrate has an array of the biological or chemical material thereon. The motion platform has an array of the substrates housed thereon. The dispenser is mounted on an X, X-Y or X-Y-Z robotic head for serially dispensing predetermined quantities of reagents on the substrates. The dispenser generally comprises a first passage for dispensing reagents onto the substrates and a second passage for blowing air on the substrates to dry the substrates.

In accordance with one preferred embodiment, the invention provides an apparatus for transferring a liquid from a source to a target. The apparatus generally comprises an aspirate-dispense device and a positive displacement pump. The aspirate-dispense device generally comprises a first passage, a second passage and a miniaturized tip. The first passage has an orifice at one end for aspirating liquid into the first passage and dispensing the liquid from the first passage. The second passage is adapted for the flow of pressurized air for mixing with the liquid dispensed from the first passage to form an aerosol mist. The miniaturized tip is formed at the first passage orifice and insertable in receptacles for aspirating the liquid to be transferred. The positive displacement pump is in fluid communication with the first passage for metering predetermined quantities of the liquid into and out of the orifice.

In accordance with another preferred embodiment, the invention provides a method of transferring a liquid from a source to a target using an aspirate-dispense device. The device has a first passage connected to a metering pump and a second passage connected to a pressurized air reservoir. The first passage has a tip at one end. The method comprises the step of inserting the tip of the device in the liquid in the source. A predetermined quantity of the liquid is aspirated into the first passage of the device by operating the pump. The tip of the device is positioned over the target. A predetermined quantity of the liquid is dispensed onto or into the target in the form of an aerosol mist by operating the pump and mixing the liquid with air flow from the reservoir.

In accordance with one preferred embodiment, the invention provides a carrier for holding a plurality of slides through a series of assaying processes. The carrier generally comprises a plurality of nests and a plurality of clamps. Each nest is sized and configured to receive one of the slides. The clamps secure the slides in the nests with each clamp being positioned at an end of each nest. Each nest comprises a through cavity such that when the slides are loaded in the nests, the upper and lower surfaces of the slides are exposed for forming and processing of microarrays of biological or chemical material thereon.

In accordance with another preferred embodiment, the invention provides a method of transporting a plurality of substrates in a cassette through a series of workstations. Each of the workstations is adapted to form or process biological or chemical microarrays on the substrates. The method comprises the step of seating the substrates in a plurality of compartments formed in the cassette. Each compartment has a through hole so that the upper and lower surfaces of the substrates are accessible for forming or processing the microarrays thereon. The substrates are secured in the compartments using a plurality of clamps. Each clamp is positioned at an end of each compartment. The substrates are transported in the cassette through the workstations by one or more movable surfaces.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a simplified flow chart of one methodology associated with the hybridization process used for developing DNA microarrays;

FIG. 2 is a schematic drawing of an aspirate-dispense aerosol apparatus having features and advantages in accordance with one preferred embodiment of the present invention;

FIG. 3 is a cross section view of one preferred embodiment of the syringe pump of FIG. 2;

FIG. 4 is a simplified front view of one preferred embodiment of the aspirate-dispense aerosol dispenser of FIG. 2;

FIG. 5 is a simplified side view of the aerosol dispenser of FIG. 4;

FIG. 6 is a schematic drawing illustrating the insertion of the tip of the aspirate-dispense aerosol dispenser of FIG. 4 into a microwell;

FIG. 7 is a simplified schematic drawing of an in-line microarray processing system having features and advantages in accordance with one preferred embodiment of the present invention;

FIG. 8 is a simplified schematic drawing of one preferred embodiment of the microarraying machine of FIG. 7;

FIG. 9 is a simplified partially schematic drawing of a batch microarray processing system having features and advantages in accordance with one preferred embodiment of the present invention;

FIG. 10 is a simplified perspective view of a multiple substrate holding cassette having features and advantages in accordance with one preferred embodiment of the present invention;

FIG. 11 is a simplified perspective view of a multiple substrate holding cassette with a plurality of substrates mounted thereon and having features and advantages in accordance with one preferred embodiment of the present invention;

FIG. 12 is a simplified top view of a multiple substrate holding cassette having features and advantages in accordance with one preferred embodiment of the present invention; and

FIG. 13 is a simplified perspective view of a stack of multiple substrate holding cassettes having features and advantages in accordance with one preferred embodiment of the present invention.

### DETAILED DESCRIPTION OF THE PREFERRED EMBODIMENTS

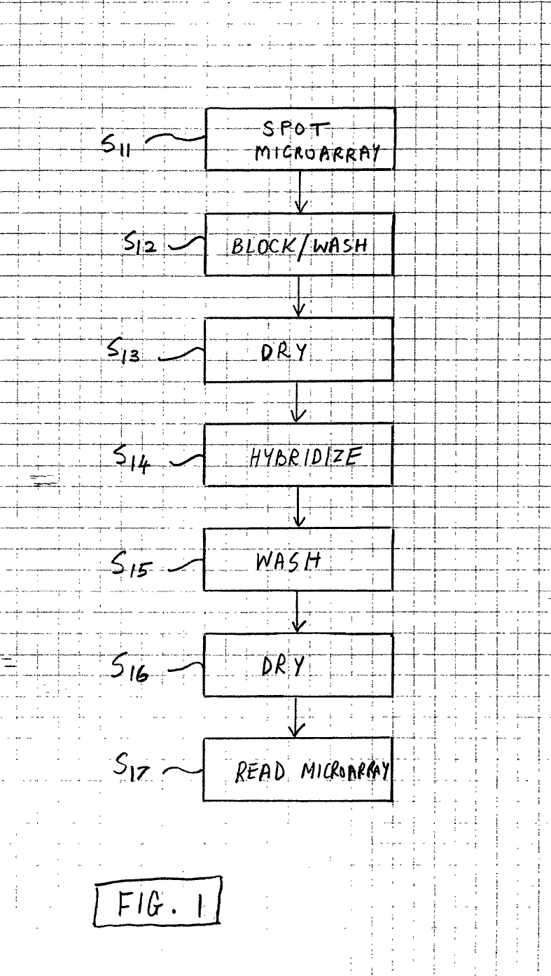

FIG. 1 is a simplified flowchart of the basic steps associated with the hybridization process used for developing DNA microarrays. In step S₁₁, a DNA microarray is spotted or created on a surface such as a microscope glass slide or other substrate. The objective of this step is to bind DNA to the substrate surface.

In step S₁₂ the substrate surface is blocked with a chemical reagent to prevent any additional surface binding on the substrate. This is followed by washing to remove excess reagents. In step S₁₃ a dry process is used to dry the excess reagents from the substrate surface.

A probe reagent or tagged DNA sample is applied to the substrate surface in step S₁₄ and the substrate is incubated under conditions that promote hybridization, binding or the reaction kinetics. These conditions typically involve heating at an elevated temperature to speed up the reaction.

In step S₁₅ the substrate is washed to remove excess probe materials and leave only attached or hybridized probes. In step S₁₆ a dry process is used to dry the excess reagents from the substrate surface. The array is then read in step S₁₇ using, for example, a laser or CCD camera. The tagged probe provides a reader signal when excited by a light source such as the laser or CCD camera.

The skilled artisan will realize that there are many different “recipes” for hybridization and binding processes. Some of these involve, several treatments with reagents and several heating and drying steps, as needed. The techniques and systems of the preferred embodiments of the present invention contemplate accommodating these different “recipes.”

In one preferred embodiment, and as discussed in greater detail below, the present invention provides inexpensive, quantitative and high throughput processing of high density microarrays of DNA, proteins and other biological or chemical reagents by utilizing an in-line processing approach. This is preferably based on a continuous indexing of microarray slides or substrates through a series of processes where different functions or processes are performed at different positions on a conveyor.

In one preferred embodiment, and as discussed in greater detail below, the present invention provides inexpensive, quantitative and high throughput processing of high density microarrays of DNA, proteins and other biological or chemical reagents by utilizing a batch process approach. Preferably, the process steps are performed serially to an array of microarray slides or substrates mounted on a movable table or carriage.

High throughput is generally defined herein as the processing of more than one hundred parts or substrates per hour. A high density microarray is generally defined herein as having 400 spots or more per square centimeter (cm²) and/or as 10,000 spots or more per substrate. Of course, other definitions may be used depending on the particular context.

In one preferred embodiment, a universal substrate cassette is provided for holding a plurality of substrates or slides through a number of process steps without the need to remove the substrates or slides from the cassette. Advantageously, this optimally minimizes or eliminates the handling of individual substrates or slides between operations or process steps.

In one preferred embodiment, the present invention provides a versatile positive displacement aerosol dispensing system which can also aspirate fluid. Advantageously, the aerosol device can be used to perform several functions during the processing of microarrays, among other functions such as coating complex shapes like bugs or leaves for agriculture applications. These include, but are not limited to, dispensing and/or aspirating of probe reagents, blocking reagents and washing reagents and drying. Other positive displacement aerosol devices are described in U.S. Pat. Nos. 5,738,728 and 5,916,524 to Tisone, the entire disclosure of each one of which is hereby incorporated by reference herein. A description of the aerosol device follows below.

Aspirate-dispense Aerosol Device

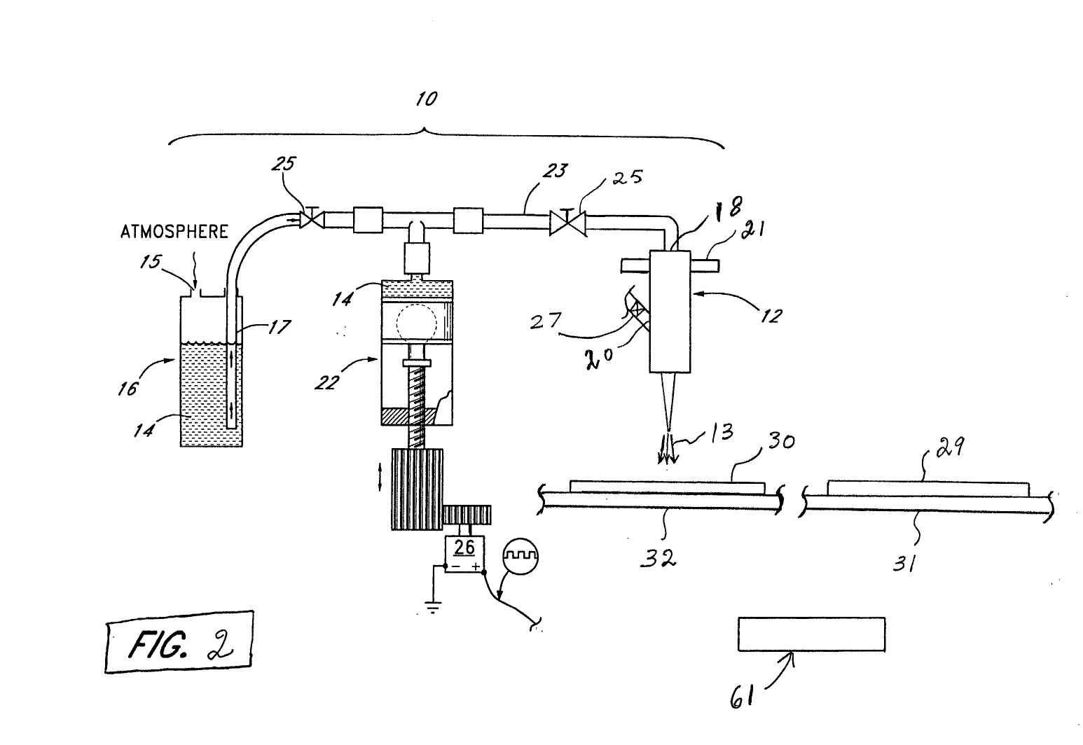

FIG. 2 is a schematic drawing of a precision-metered aspirate-dispense aerosol apparatus or system 10 having features and advantages in accordance with one preferred embodiment of the present invention. The fluid handling, delivery or transfer apparatus 10 generally comprises an aspirate-dispense aerosol dispenser or airjet 12 connected in series with a positive displacement syringe pump 22 intermediate a reservoir 16. The aerosol dispenser 12 preferably has two inlet ports 18, 20. One port 20 is connected to a reservoir or source of pressurized air which atomizes the dispensed reagent or liquid and mixes with it to form a fine mist. A valve 27 is provided to open and close the connection between the source of pressurized air and the port 20. The other port 18 is connected to the positive displacement pump 22 which meters the flow of reagent from and into the aspirate-dispense head 12.

The aerosol dispenser or airbrush 12 is used to aspirate a predetermined quantity of liquid or reagent from a source or receptacle 29 and dispense a predetermined quantity, in the form of a spray pattern, of the aspirated fluid or reagent 13 onto or into a target 30. The positive displacement pump 22 meters the volume and/or flow rate of the liquid or reagent aspirated, and more critically, of the reagent or liquid dispensed.

The reservoir 16 contains a wash or system fluid, such as distilled water, which fills most of the aspirate-dispense system 10. In the case when large amounts of the same reagent or liquid are to be dispensed, the system may be filled with the particular liquid or reagent 14 that is to be dispensed. Also, multiple aerosol systems 10 may be efficaciously utilized to form a line or array of aerosol dispensers 12.

Preferably, the aspirate-dispense system 10 or the aerosol dispenser 12 are mounted on an X, X-Y or X-Y-Z motion head or robotic system 21 to provide relative motion between the dispenser 12 and the source 29 and target 30. Alternatively, or in addition, the source 29 and the target 30 are mounted on X, X-Y or X-Y-Z platforms, tables or carriages 31 and 32.

The fluid source 29 comprises a microtiter plate or one or more small containers or receptacles holding the liquid or reagent that is to be dispensed. The target 30 can comprise a microscope glass slide, a microtiter plate, a solid substrate, a porous membrane or any other suitable wet or dry surface capable of receiving a dispensed reagent or other liquid. The substrate such as a glass slide may be coated, plain or membrane coated.

A positive displacement pump for use in accordance with one particular embodiment of the present invention may be any one of several varieties of commercially available pumping devices for metering precise quantities of liquid. A syringe-type pump 22 is preferred because of its convenience and commercial availability.

A wide variety of other positive displacement pumps or “direct current” fluid sources may be used, however, to achieve the benefits and advantages as disclosed herein. These may include, for example and without limitation, rotary pumps, peristaltic pumps, squash-plate pumps, pumps incorporating hydraulic or electronic control and the like.

Advantageously, in accordance with the present invention absolute volume or flow rate is an input parameter controlled by the metering pump 22. Thus, the programmable flow rate and/or volume of reagent dispensed is determined substantially solely by the positive displacement pump 22.

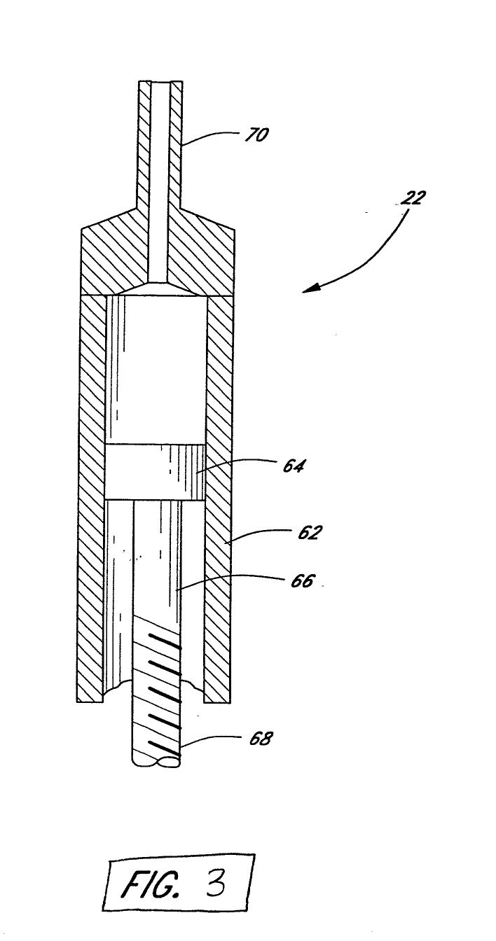

As illustrated in more detail in FIG. 3, the syringe pump 22 generally comprises a syringe housing 62 of a predetermined volume and a plunger 64 which is sealed against the syringe housing by O-rings or the like. The plunger 64 mechanically engages a plunger shaft 66 having a lead screw portion 68 adapted to thread in and out of a base support (not shown).

Those skilled in the art will readily appreciate that as the lead screw portion 68 of the plunger shaft 66 is rotated the plunger 64 will be displaced axially, either forcing liquid 14 from the syringe housing 62 into the exit tube 70 or drawing liquid 14 into the syringe housing 62 depending on whether the plunger is incremented or decremented. Any number of suitable motors or mechanical actuators may be used to drive the lead screw 68. Preferably, a stepper motor 26 (FIG. 2) or other incremental or continuous actuator device is used so that the amount and/or flow rate of liquid 14 or reagent to be dispensed and/or aspirated can be precisely regulated.

Suitable syringe pumps are commercially available, such as the Bio-Dot CV1000 Syringe Pump Dispenser, available from Bio-Dot, Inc. of Irvine, Calif. This particular syringe pump 22 incorporates an electronically controlled stepper motor 26 for providing precision liquid handling using a variety of syringe sizes. The CV1000 is powered by a single 24 DC volt power supply and is controlled via an industry-standard RS232 or RS485 bus interface. The syringe pump 22 may have anywhere from 3,000-24,000 steps, although higher resolution pumps having 48,000 to 192,000 steps or more may also be used to enjoy the benefits of the invention herein disclosed. Higher resolution pumps, such as piezoelectric pumps, may also be used to provide even finer resolutions as desired.

The lead screw 68 may optionally be fitted with an optical encoder or similar device to detect any lost steps. Alternatively, the lead screw of the metering pump can be replaced with a piezoelectric slide to provide both smaller volume increments and also faster acceleration/deceleration characteristics. Multiple syringe pumps 22 may also be used in parallel, for example when the liquid 14 comprises a reagent to be dispensed, for delivering varying concentrations of reagent and/or other liquids to the dispenser 12 or for alternating dispensing operations between two or more reagents.

The travel of the plunger 64 is preferably about 260 millimeters (mm). Plunger speeds may range from 0.8 seconds per stroke with a 10-step minimum for low-resolution pumping or 1.5 seconds per stroke with a 20-step minimum for high-speed resolution pumping. The stroke speed may vary depending upon the syringe size and the tubing used. Syringes may vary from less than 50 microliters (μL) to 25 milliliters (μL), or more as needed. For most reagent dispensing applications it should be adequate to provide a syringe having a volume from about 500 microliters (μL) to about 25 milliliters (μL).

The minimum incremental displacement volume of the pump 22 will depend on the pump resolution and syringe volume. For example, for a syringe housing volume of 500 microliters (μm) and 12,000 step resolution pump the minimum incremental displacement volume will be about 42 nanoliters (nL). Minimum incremental displacement volumes from about 0.5 nanoliters (nL) to 2.1 milliliters (mL) are preferred, although higher or lower incremental displacement volumes may also be used while still enjoying the benefits of the present invention.

The syringe housing 62 may be made from any one of a number of suitable bio compatible materials such as glass, Teflon™ or Kel-F. The plunger 64 is preferably formed of virgin Teflon™. Referring to FIG. 2, the syringe pump 22 is connected to the reservoir 16 and the dispenser 12 using a Teflon tubing 23, such as 6.35 mm (¼-inch) O.D. tubing provided with luer-type fittings for connection to the syringe and dispenser. Various shut-off valves 25 or check valves (not shown) may also be used, as desired or needed, to direct the flow of liquid 14 to and from the reservoir 16, syringe pump 22 and aspirate-dispense aerosol dispenser 12.

The reservoir 16 may be any one of a number of suitable receptacles capable of allowing a liquid or reagent 14 to be siphoned into pump 22. The reservoir may be pressurized, as desired, but is preferable vented to the atmosphere, as shown, via a vent opening 15. The particular size and shape of the reservoir 16 is relatively unimportant.

A siphon tube 17 extends downward into the reservoir 16 to a desired depth sufficient to allow siphoning of liquid or reagent 14. Preferably the siphon tube 17 extends as deep as possible into the reservoir 16 without causing blockage of the lower inlet portion of the tube 17. Optionally, the lower inlet portion of the tube 17 may be cut at an angle or have other features as necessary or desirable to provide consistent and reliable siphoning of liquid 14.

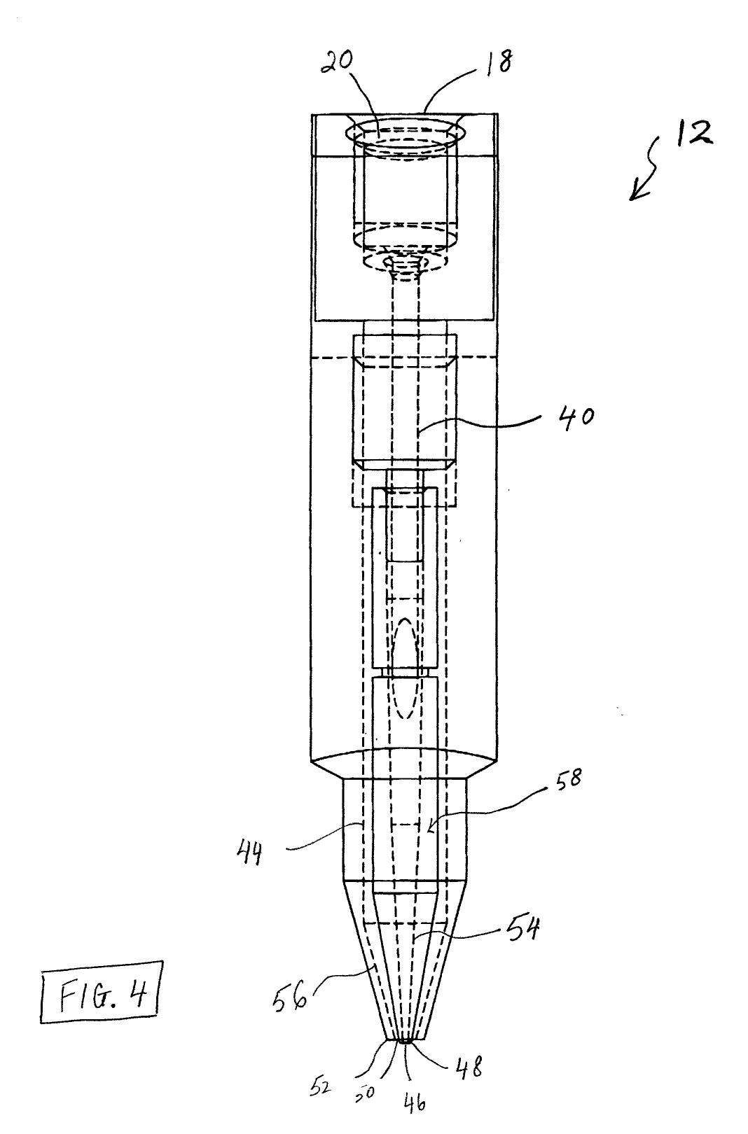

FIGS. 3 and 4 show the aspirate-dispense aerosol dispenser or device 12 in more detail. The dispenser inlet port 18, which is connected to the pump 22, leads into a generally cylindrical passage 40 having an exit orifice 46 at a tapered end or tip 48. The passage 40 preferably has a tapered portion 54 which terminates at the orifice or opening 46. Preferably, the passage 40 is configured such that capillary action and surface tension at the exit orifice 46 prevent leakage of any liquid from the orifice 46 when the system is in dormant or non-dispense mode. Optionally, an axially displaceable needle valve may be provided within the passage 40 to open and close the orifice 46.

The dispenser inlet port 20, which is connected to a pressurized air source, leads into a generally cylindrical first passage 42 and then into a generally annular second passage 44 having an exit orifice 50 at a tapered end or tip 52. The passage 44 preferably has a tapered portion 56 which terminates at the orifice or opening 50. The passage 44 generally circumscribes at least a portion of the fluid passage 40.

As best seen in FIGS. 3 and 4, the tip 48 preferably extends slightly beyond the tip 52 and the annular air exit orifice 50 generally circumscribes the tip 48 a small distance above the circular liquid exit orifice 48. Alternatively, the tip 48 extends further away from the orifice 50. As pressurized air flows out of the orifice 52 at a high velocity it atomizes the reagent or liquid exiting the orifice 48 and produces a fine aerosol mist which is uniformly deposited on the target 30.

Thus, the aerosol stream is created by a combination of a programmable volumetric flow of reagent as determined by the syringe pump 22 and an air flow across the dispense tip 48. Preferably, the air flow is fed at a predetermined constant air pressure set by a regulator to create a predetermined air flow profile or pattern.

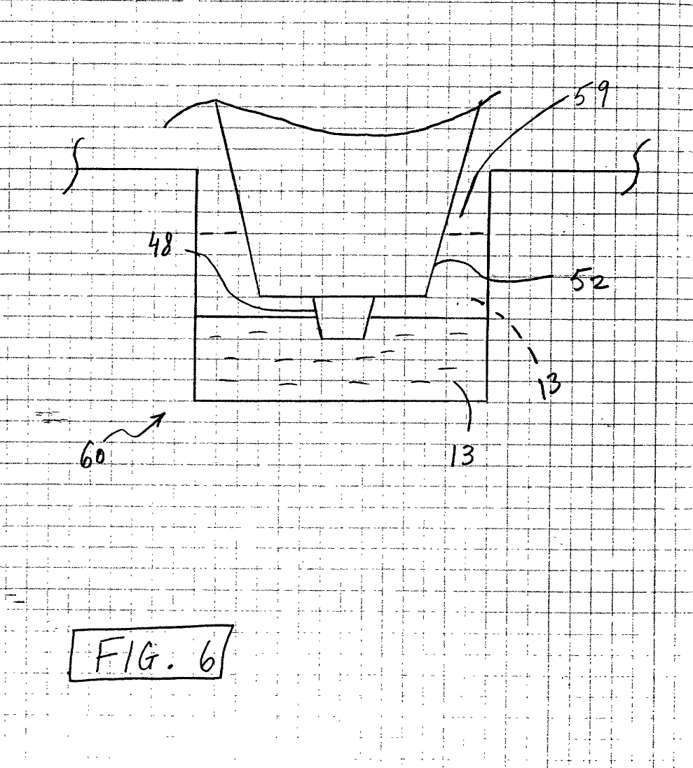

Advantageously, the miniaturized or small tip 48 also serves as an aspirate tip to suck or aspirate liquids or reagents from the source 29. The tip 48 can be dimensioned in various manners. In one preferred embodiment, the outer diameter of the tip 48 is such that it can be inserted into the microwells 59 of microtiter plates 60 (see FIG. 6) such as 96, 384, 1536 well microtiter plates, among other small containers or receptacles containing source liquid, to aspirate the source reagent 13. This capability to aspirate a liquid or reagent and dispense it in the form of an aerosol mist or spray pattern, desirably, adds to the versatility of the invention.

Conventional microtiter plates typically have microwells which have a diameter or length/width in the range from about 1 mm to about 8 mm. As indicated above, the aspirate-dispense tip 48 is preferably dimensioned and configured to accommodate insertion into these microwells.

In one preferred embodiment, the inner diameter of the tip 48 or the diameter of the orifice 46 is between about 50.8 μm (0.002 inches) to about 254 μm (0.01 inches), the outer diameter of the tip 48 is between about 500 μm to about 2000 μm, and the liquid flow tip 48 extends beyond the air flow tip 52 by a distance of between about 1 mm to about 10 mm. In other preferred embodiments, the tip 48 and orifice 46 may be dimensioned and configured in alternate manners, as required or desired, giving due consideration to the goals of achieving one or more of the benefits and advantages as taught or suggested herein.

In one preferred embodiment, the inner diameter of the tip 52 or the outer diameter of the orifice 50 is between about 600 μm to about 2200 μm, the outer diameter of the tip 52 is between about 1 mm to about 6 mm, and the inner diameter of the annular orifice 50 is between about 600 μm to about 5000 μm. In other preferred embodiments, the tip 52 and orifice 50 may be dimensioned and configured in alternate manners, as required or desired, giving due consideration to the goals of achieving one or more of the benefits and advantages as taught or suggested herein.

The tip 48 is preferably formed from a ceramic material, and more preferably from alumina. In one preferred embodiment, a tube 58 comprising a ceramic material, and preferably alumina, is used to form at least the lower portion of the fluid passage 40. Advantageously, the ceramic material is chemically inert to most reagents and solvents, and is also mechanically robust. In other preferred embodiments the tip 48 and/or the material forming the passage 40 can be efficaciously fabricated from a wide variety of materials such as other ceramics, metals, alloys, plastics, as required or desired, giving due consideration to the goals of providing chemical inertness and robustness, and/or of achieving one or more of the benefits and advantages as taught or suggested herein.

The material forming the air passages 42, 44 and/or the outer housing or body of the dispenser 12 preferably comprises a chemically inert material such as aluminum, stainless steel or polyetheretherketone (PEEK). In other preferred embodiments the material forming the air passages 42, 44 and/or the outer housing or body of the dispenser 12 can be efficaciously fabricated from a wide variety of materials such as other metals, alloys, plastics, ceramics, as required or desired, giving due consideration to the goals of providing chemical inertness, and/or of achieving one or more of the benefits and advantages as taught or suggested herein.

In one preferred embodiment, the size of the droplets forming the aerosol mist dispensed from the aerosol jet 12 is about 10 picoliters (pL) or less. In another preferred embodiment, the size of the droplets forming the aerosol mist dispensed from the aerosol jet 12 is in the range from about 10 picoliters (pL) to about 1 nanoliters (nL). Alternatively, the droplet size may be more or less, as needed or desired, giving due consideration to the goals of achieving one or more of the benefits and advantages as taught or suggested herein.

Preferably, the spot size or size of the dispersion pattern formed by the aerosol mist on a generally flat target is in the range from about 1 centimeters (cm) to about 2 centimeters (cm). In other preferred embodiments, the spot size may be more or less, as needed or desired, giving due consideration to the goals of achieving one or more of the benefits and advantages as taught or suggested herein. Higher air input pressures will generally result in wider dispersion patterns.

The operation of the aspirate-dispense aerosol system 10 is preferably monitored and controlled by a feedback control system utilizing a central controller. The controller is interfaced with the pump 22, the pressurized air source, the motion system 21 and the platforms 31, 32 among other associated components of the system 10 to control and coordinate the various operations of the system.

In operation, the tips 48, 52 or only the extended tip 48 are dipped into the liquid or reagent in the source 29, such as a microwell 59 (FIG. 6), and the syringe pump 22 is decremented to aspirate a predetermined and precise quantity of reagent into the aerosol dispenser 12. Thus, both the aspirate-dispense tip 48 and the air tip 52 may contact the reagent 13 in the microwell 59.

The tip 48 is then positioned over the target 30 and the syringe pump 22 incremented along with actuation of pressurized air flow through the orifice 50 to atomize a predetermined amount of the dispensed fluid from the orifice 48 and spray it onto or into the target 30. During spraying relative motion can be provided between the tip 48 and the target 30 to uniformly coat the surface of the target 30, such as a glass slide or membrane, with the dispensed reagent. Multiple passes may be utilized, as necessary or desired, to dispense a programmed or predetermined volumetric amount of the reagent. Any excess reagent is purged by dispensing in a waste position by incrementing the syringe 22 to prepare for the next aspiration.

During aspiration, preferably the syringe pump plunger 64 is decremented at an optimally slow speed so that the reduced or negative aspirate system pressure is kept close to zero. As a result, the flow of source fluid or reagent into the tip 48 and passage 40 is maintained generally laminar. The displacement rate of the syringe pump plunger 64 is dependent on the volume to be aspirated, but it is typically in the range of about 0.5 to 50 μL/sec. For aspiration of very small volumes the plunger displacement rate is about 0.5 μL/sec. Thus, turbulent mixing of source fluid or reagent with system fluid 14 is reduced, and any dilution of the source fluid or reagent will essentially be due to diffusion. Advantageously, in most cases, at or near room temperature, the diffusion process is very slow, and hence the overall effective dilution of the source fluid or reagent is small or negligible. After aspiration, and prior to dispensing of reagent, the syringe pump plunger 64 may be incremented to prime the system for dispensing operation.

The tapered portion 54 of the fluid passage 40 causes smaller local pressure drops to be generated within the passage 40 during dispensing and aspiration. This improves the performance of the system 10 in terms of less precipitation of gaseous bubbles within the source reagent and/or the system fluid 14. The tapered portion 54 also results in reduced mixing of source reagent with the system fluid 14 by further improving the generally laminar flow during aspiration. Advantageously, this reduces the wastage of valuable reagent.

During aspiration, some source reagent may adhere to the outer surfaces of the tips 48, 52 or only the extended tip 48, depending on whether only the tip 48 comes in contact with the reagent or both tips 48, 52 contact the reagent. Advantageously, the tapered tip 48 and its small outer diameter leads to little or less accumulation of fluid on the outer surface of the tip 48. A wash workstation 61 is preferably used to wash the tips 48, 52 or only the extended tip 48 in a cleaning fluid, for example, distilled water, among others, to remove any excess reagent. Alternatively, the tips 48, 52 or only the extended tip 48 can be dipped in a volatile solvent such as isopropyl alcohol, among others, to help maintain a dry tip. Also, a chemically inert and mechanically robust hydrophobic coating can be applied to the outer surfaces of the tips 48, 52 or only the extended tip 48 to assist in keeping them or it free of excess fluid. Suitable hydrophobic coatings include, for example, silicon nitride, silicon carbide, titanium nitride, among others.

The wash station can also comprise a vacuum dry system. The vacuum dry system preferably comprises one or more vacuum orifices connected to a suction pump. The tips 48, 52 or only the extended tip 48 is inserted into one of the vacuum orifices which sucks or removes excess reagent from the outer surfaces of the tips 48, 52 or only the extended tip 48.

During aspiration it is possible that some source reagent may enter the air passage 44 through the orifice 50, especially in the case when the housing tip 52 contacts source reagent 13 during aspiration (see FIG. 6). Thus, using an extended aspirate-dispense tip 48 can avoid the situation of reagent entering the air path 44 through the orifice 50.

The air passage 44 can be cleaned and/or washed by dipping in a wash solution and/or by using a vacuum dry system to suck any reagent from the air passage 44. Alternatively, or in addition, the reagent can be blown out into a waste position by activating the pressurized air flow through the passage 44. Alternatively, or in addition, during the wash a negative or reduced pressure is used to suck some cleaning or wash solution into the passage 44 which is then blown out by the application of a positive or increased pressure. Alternatively, or in addition, during aspiration a positive pressure is maintained in the air passage 44 so that source reagent is substantially blocked from entering the air passage 44.

One operational advantage achieved by the aerosol system 10 of the present invention is that over a given range the flow of reagent is substantially independent of the input air pressure, the dispense orifice size and the particular fluid and/or flow characteristics of the reagent. This is because the quantity of reagent dispensed is precisely controlled by the positive displacement pump 22. This has particular advantage, for example, in applications requiring a very fine mist of reagent or for higher viscosity reagents, since the reagent flow rate and/or volume dispensed can be precisely controlled without substantial regard to the operational parameters of the dispenser 12, fluid viscosity, fluid density, surface tension and other fluid and/or flow parameters. Also, reagent dispersion patterns, mist quality or droplet size can be varied dramatically.

The aerosol system 10 of the present invention also has particular advantage for high production processing. In certain production applications, for example, it may be desirable to provide a very fine mist of reagent with a given dispersion to provide optimal coating characteristics. At the same time, it is desirable to provide high reagent flow rates for increased production levels. The present invention allows the use of a small dispense orifice opening to attain high flow rates by positively displacing the reagent through the orifice opening 46. In other words, the flow of reagent is not substantially dependent on the orifice size. It is dependent only on the displacement of the syringe pump 22 which acts as the forcing function for the entire system.

In other words, the syringe pump 22 of the system acts as a fluid current source and forces a given volume per step into the system. The force available from the stepper motor 26 is essentially infinite, due to the large gear ratio to the syringe input. The input is impeded from the forces feeding back from the system. Since volume, V, is the integral of the flow rate:

V=∫Qdt (1)

and the flow rate, Q, is modeled as current, the syringe pump 22 is therefore a current source rather than a pressure (voltage) source. Since any impedance in series with a current source has no effect on the flow rate, this has the beneficial effect of removing the influence of the system flow impedance, such as that of the compliant feedline 23, on the flow rate. Advantageously, this solves a major problem that would be present if a pressure source were used as the driving function. For a pressure source, the system flow impedance would offer a changing and/or unpredictable resistance to flow and could give rise to hydraulic hammer pressure pulses and varying pressure drops across the which could affect the flow rate through the dispense system, and hence the fluid output. By utilizing a current source, such as the syringe pump 22, the effect of changes in flow or fluid impedance is substantially negligible or none on the flow rate, and thus accurate and repeatable fluid volumes can be readily dispensed.

In one preferred mode of operation, the programmed motion control between the dispenser 12 and the target 30 can be coordinated with the metering pump 22 to deliver a desired volume per unit length, with the ability to also independently control the dispersion pattern and mist quality of the reagent being delivered. For example, it is possible to deliver reagent at a rate of 1 microliter per centimeter at a constant relative motion speed with a given spray dispersement pattern and mist quality. The timing and coordination of the movable dispenser 12 relative to the syringe pump 22 and movable target 30 can be accomplished using any one of a number controllers well known in the art. Typical controllers are microprocessor based and provide any one of a number of output control pulses or electrical signals of predetermined phase, pulse width and/or frequency. These signals may be used, for example, to control and coordinate the syringe pump 22, movable carriages 31, 32 and the dispenser 12 in accordance with the present invention.

In this context, there are two desirable modes of dispensing operation: (1) line or continuous dispensing; and (2) spot dispensing. In the case of continuous dispensing, the pump 22 is set to a predetermined flow rate to deliver a metered volume of reagent per unit time. For example, the flow rate could be programmed to deliver 1 microliter per second. The syringe pump 22 will then deliver reagent to the dispense orifice 46 at the predetermined rate. The dispenser 12 will mix the reagent with air, forming a mist that is deposited on the target 30. Thus, in the continuous operation mode, the system is not only capable of delivering precise metered flow rates of reagent, but this can be done with independent control of relative motion speed, reagent concentration per unit length, and mist quality. If desired, a continuous drive liquid pump may be used to assure a steady flow rate of reagent to the dispense orifice 46, rather than a pulsed flow.

A second mode of operation involves dispensing “spot” spray patterns at preprogrammed positions. This may be done, for example, by synchronizing the displacement pump 22 and dispenser 12 with programmed motion of the platform 32. A dispensing apparatus in accordance with the present invention will provide a minimum dispense volume determined by the metering pump increment, i.e., a 50 microliter (μm) syringe with 12,000 steps will provide an incremental displacement volume of 4.16 nanoliters (nL).

The skilled artisan will readily recognize the versatility and utility of the aspirate-dispense aerosol system 10 of the present invention. The aerosol system 10 can accurately aspirate and/or dispense precise and predetermined quantities of liquids for various applications and functions. As discussed further below, advantageously, the dispensed aerosol mist can be used to uniformly and quantitatively apply different reagents to a substrate for processing and assaying of microarrays of DNA, proteins and other biological or chemical reagents. The pressurized air flow from the dispenser 12 can be used to facilitate drying processes and this further adds to the versatility of the invention.

In-line Processing of Microarrays

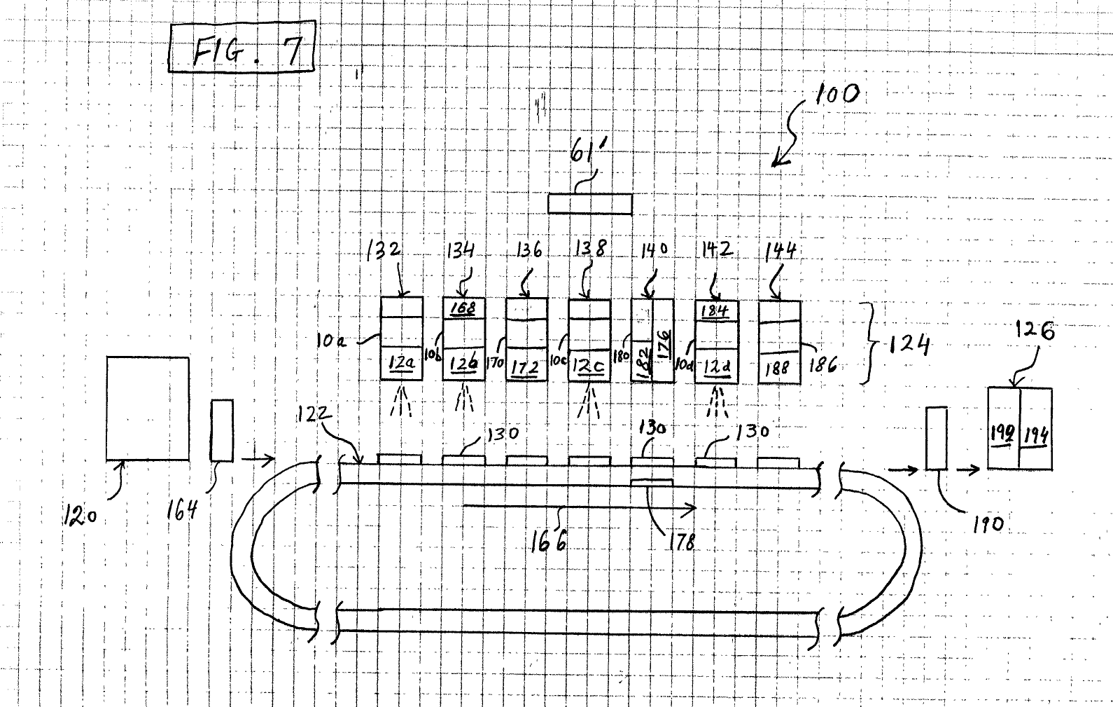

FIG. 7 is a schematic view of an in-line microarray processing system 100 having features and advantages in accordance with one preferred embodiment of the present invention. Advantageously, the in-line system 100 provides inexpensive, quantitative and high throughput processing of microarrays of DNA, proteins and other biological or chemical reagents. This is preferably based on a continuous indexing of microarray slides or substrates through a series of processes where different functions or processes are performed at different positions on a conveyor.

In one preferred embodiment, and as discussed later herein, a cassette or carrier with nests is provided to hold a plurality of slides or substrates through the series of processes performed on the substrates. Thus, multiple substrate-holding cassettes would be transported on the conveyor, similar to the transportation of individual substrates. Advantageously, this facilitates in the automatic handling of substrates and enhances process efficiency. Moreover, a combined in-line and batch processing capability is achieved.

The in-line system 100 advantageously processes between about 200 to about 2000 or more high density microarrays, substrates or glass slides per day. This has application in a high throughput setting such as a clinical laboratory environment. In other words, the in-line system 100 advantageously processes between about 35 to about 350 or more high density microarrays, substrates or glass slides per hour. Conventional technologies as presently practiced can only process tens of such microarrays per day.

The in-line microarray processing system 100 generally comprises a spotting or microarraying machine or workstation 120, a conveyor 122 for transporting substrates or glass slides 130, a plurality of processing stations or workstations 124 for performing various processes at different positions along the conveyor 122, and a detection and analysis system 126 to read the hybridized or bound microarrays. The substrates 130 are preferably fed to the conveyor 122 utilizing a feeder or pick-and-place system 164 or the like. In one preferred embodiment, the plurality of processing stations 124 comprises a blocking workstation 132, a first wash workstation 134, a dry workstation 136, a probe addition workstation 138, an incubation workstation 140, a second wash workstation 142 and a second dry workstation 144.

The skilled artisan will realize that there are many different “recipes” for processing, assaying and developing reagent microarrays. Some of these involve, several treatments with reagents and several heating and drying steps, as needed. Thus, the preferred embodiments of the present invention can efficaciously utilize fewer or more processing stations, as required or desired, giving due consideration to the goals of achieving high throughput, and/or of achieving one or more of the benefits and advantages as taught or suggested herein.

In one preferred embodiment, the spotting or microarraying machine 120 comprises a contact fluid dispensing system, for example, using an array of spotting pins, tips and the like. Alternatively, the spotting or microarraying machine 120 comprises a non-contact fluid dispensing system, for example, using ink jet technology and the like. The microarraying machine 120 is used to bind DNA, proteins or other biological or chemical reagents, preferably in a predetermined array pattern, on the surface of the substrates 130.

A substrate having a DNA microarray formed on its surface is sometimes referred to as a “DNA chip”, a “biochip”, a “hybridization chip” or a “geosensor chip.” The DNA microarray itself is sometimes referred to as a “DNA chip.” Some other types of microarrays or microchips that may be formed and processed by the invention include protein microarrays, cDNA microarrays, RNA microarrays, oligonucleotide arrays among others.

Preferred embodiments of a microarraying machine which deposits liquid via “touch-off” are described in PCT International Publication No. WO 00/01798 (International Application No. PCT/US99/15214) to Rose et al. and pending U.S. patent application Ser. No. 09/459,245 to Rose et al., the entire disclosure of each one of which is hereby incorporated by reference herein. These disclose a random access array or print head of ceramic tips or capillary tubes which are dipped into wells of a microtiter plate or other liquid or reagent source to draw or aspirate liquid(s) into respective inner lumens of the tips. The ends of the tips are contacted (“touch-off”) with a target substrate, glass slide or membrane to transfer, deposit or spot the liquid(s) in the form of a predetermined pattern or high-density microarray. The ceramic tips preferably have tapered nozzle portions. Solenoid actuated magnets are used to selectively raise and lower the capillary tips to selectively aspirate liquid from a desired position and selectively deposit it at a desired position. A wash/dry station is preferably used to clean and dry the capillary tips. As the skilled artisan will recognize, other contact dispensing pins as known in the art such as those comprising thin rods of stainless steel with sharp points and slotted pins can be efficaciously utilized, as needed or desired.

Preferred embodiments of a microarraying machine which deposits liquid via non-contact dispensing are described in PCT International Publication No. WO 00/01798 (International Application No. PCT/US99/15214) to Rose et al. and pending U.S. patent application Ser. No. 09/459,245 to Rose et al., the entire disclosure of each one of which is hereby incorporated by reference herein. These disclose an array of solenoid actuated dispensers arranged in series with respective positive displacement pumps to precisely aspirate predetermined quantities of liquids from a microtiter plate or other liquid or reagent source and precisely dispense predetermined quantities of aspirated liquid onto or into a target substrate, glass slide or membrane to form a predetermined pattern or high-density microarray. Positive displacement dispensing technology is also disclosed in U.S. Pat. Nos. 5,741,554, 5,743,960 and 5,916,524 to Tisone and U.S. Pat. No. 6,063,339 to Tisone et al., the entire disclosure of each one of which is hereby incorporated by reference herein. As the skilled artisan will recognize, other dispensing technologies as known in the art such as piezoelectric dispensers, fluid impulse dispensers, heat actuated dispensers and the like may be efficaciously utilized, as needed or desired.

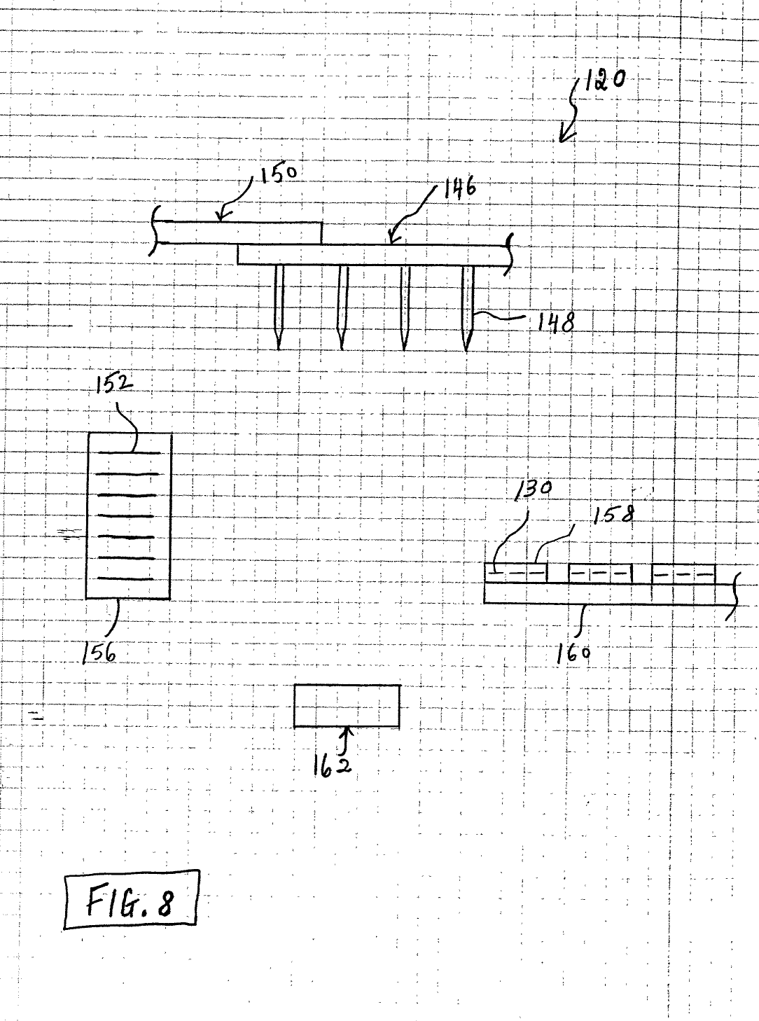

Referring to FIG. 8, in one preferred embodiment, the microarraying or spotting device 120 generally comprises a tip or pin head 146 including a plurality of tips or pins 148. A robot arm, robotic system or motion system 150 provides X, X-Y or X-Y-Z motion to the head 146. The head 146 comprises between about 1 to 384 pins or tips 148 arranged in an about 2.5 mm, 4.5 mm or 9 mm spacing to preferably conform to the spacing between microwells on conventional microtiter plates.

The tips or pins 148 are dipped into microwells or other source(s) of liquid and touched-off on a target substrate, glass slide, membrane or other porous or solid surface to transfer, spot or dot small sub-microliter microfluidic volumes (in the picoliter range to about 100 nanoliters (nL) or more) of reagent or liquid in the form of a microarray or other predetermined pattern. The spots or dots have a diameter in the range from about 50 microns (μm) to greater than about 500 microns (μm).

The size of the slides or substrates can vary from about 25 mm×75 mm for a microscope slide and about 85 mm×128 mm for microwell plate size glass slides or cassettes. Using microwell plate size substrates allows the use of conventional plate handlers and the like. The spot or dot density on the substrate or microscope glass slide can vary from between about less than 100 dots per substrate or slide to about over 100,000 dots per substrate or slide. The microarrays can have a density per unit surface area that varies from less than about 10 dots/cm² to about 6,000 dots/cm².

The microarraying system 120 preferably further comprises one or more microtiter plates 152 and a tooling plate 160 including a plurality of nests 158 with each holding one or more substrates or glass slides 130. Each nest 158 can hold up to about one hundred slides or substrates 130 or more. In certain embodiments, especially when dealing with large spot or densities in excess of 384 spots per substrate, more than one microtiter source plate 152 may be needed to add new chemistries or reagents. For high density microarrays, the number of microtiter plates 152 utilized is up to about one hundred or more. In this case, the microarraying system further comprises one or more automatic stackers 156 to automatically replace or change source microtiter plates 152.

Other pick-and-place systems, feeder systems, stackers, carriers, X, X-Y, X-Y-Z or rotary motion providing tables, carriages or platforms and the like can be efficaciously used in conjunction with the microarraying system 120 to move, pick or place selected components or associated components of the system, as necessary. For example, the microtiter plates 152, the glass slides 130, the stacker 156, the nests 158 and the tooling plate 160.

The microarraying system 120 preferably further comprises a wash/dry system 162. The wash/dry station 162 preferably comprises a wash bath, a vacuum dry system and an ultrasonic bath. The tips or pins 148 are treated one or more times in each of the wash bath, the vacuum dry system and the ultrasonic bath, as necessary, to accordingly clean and dry the tips or pins 148.

The conveyor 122 (FIG. 7) is preferably an indexing conveyor. Alternatively, the conveyor 122 can comprise a continuous conveyor, as needed or desired. As indicated above, different processes are performed at different positions along the conveyor 122. Different process times are accommodated using different conveyor lengths. For example, if the conveyor 122 indexes a substrate or glass slide 130 at a rate of one substrate every 10 seconds then a dry process of 60 seconds would be performed over six index positions. Advantageously, the conveyor length can be scaled to manufacturability depending on the throughput or output requirements of the particular application.

In one preferred embodiment, the conveyor 122 comprises a continuous indexing “walking beam” conveyor to provide rapid, incremental indexing linear motion in the direction 166. Walking beam conveyors are known in the art. They lift, move forward and lower individual substrates 130 between index positions. Spaced fixtures on the conveyor 122 are adapted to hold individual slides or substrates 130. The conveyor length, index distance, index motion among others are optimized for the particular application. An index drive system is used to power the conveyor 122. Alternatively, other types of conveyors or linear motion systems such as belt, roller or chain conveyors can be efficaciously utilized, as needed or desired. A drain or collection trough is provided to receive any excess liquids from the conveyor track.

The blocking station 132 (FIG. 7) performs the function of uniformly applying a coating of blocking reagent to the substrates or slides 130. Thus, after the microarraying step, this prevents any additional surface binding of the microarrayed DNA, proteins or other chemical or biological reagents on the substrates or slides 130. The blocking reagent is preferably dispensed in the form of an aerosol mist to provide a quantitative and programmable delivery of blocking reagent per unit area of each substrate or glass slide 130.

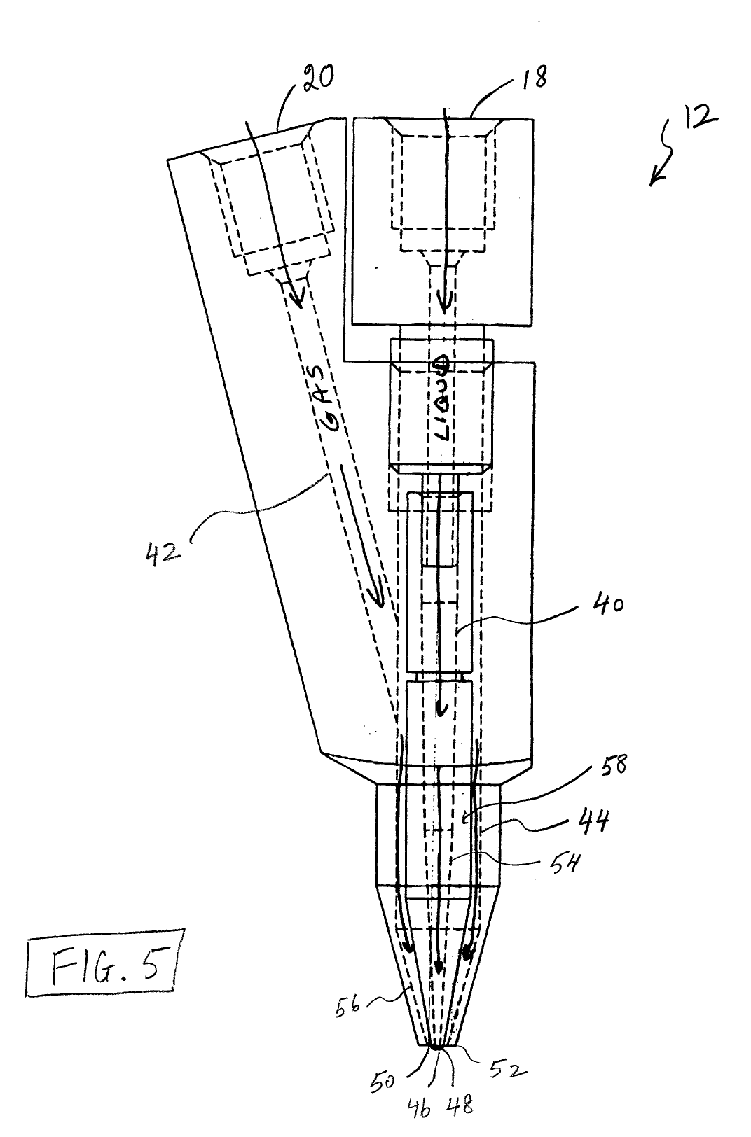

In one preferred embodiment, the blocking station 132 comprises a positive displacement aerosol system 10a including an aerosol dispenser 12a, as discussed above and shown in FIGS. 2-5 (like reference numerals refer to like elements). Also as discussed above, the dispenser 12a is preferably mounted on a X, X-Y or X-Y-Z motion head or robotic system. Thus, multiple passes of the dispenser 12a may be performed over one or more of the substrates or glass slides 130, as needed or desired, to dispense a programmed or predetermined volumetric amount of the blocking reagent on each substrate or slide 130. Advantageously, this reduces or minimizes the wastage of valuable reagent.

The dispenser 12a may aspirate blocking reagent from a source and then dispense it on the substrate or glass slide 130, as needed. Alternatively, most of the system 10a may be filled with a blocking reagent (as opposed to system liquid), particularly in the case when large volumes of the same blocking reagent are to be dispensed. The blocking station 132 can also utilize other suitable aerosol dispense systems such as positive displacement systems described in U.S. Pat. Nos. 5,738,728 and 5,916,524 to Tisone, the entire disclosure of each one of which is hereby incorporated by reference herein.

The wash station 134 (FIG. 7) performs the function of uniformly applying a coating of washing solution or reagent to the substrates or slides 130. Thus, after the step of applying blocking reagent, this removes any excess blocking reagents on the substrates or slides 130. The washing reagent is preferably dispensed in the form of an aerosol mist to provide a quantitative and programmable delivery of washing reagent per unit area of each substrate or glass slide 130.

In one preferred embodiment, the wash station 134 comprises a positive displacement aerosol system 10b including an aerosol dispenser 12b, as discussed above and shown in FIGS. 2-5 (like reference numerals refer to like elements). Also as discussed above, the dispenser 12b is preferably mounted on a X, X-Y or X-Y-Z motion head or robotic system. Thus, multiple passes of the dispenser 12b may be performed over one or more of the substrates or glass slides 130, as needed or desired, to dispense a programmed or predetermined volumetric amount of the washing reagent on each substrate or slide 130. Advantageously, this reduces or minimizes the wastage of valuable reagent.

The dispenser 12b may aspirate washing reagent from a source and then dispense it on the substrates or glass slides 130, as needed. Alternatively, most of the system 10b may be filled with a washing reagent (as opposed to system liquid), particularly in the case when large volumes of the same washing reagent are to be dispensed. The wash station 134 can also utilize other suitable aerosol dispense systems such as positive displacement systems described in U.S. Pat. Nos. 5,738,728 and 5,916,524 to Tisone, the entire disclosure of each one of which is hereby incorporated by reference herein.

In one preferred embodiment, the wash station 134 comprises a pick-and-place system 168 to pick substrates or slides 130 from the conveyor track and dip them offline in a bath containing washing solution or reagent. If desired, the pick-and-place system 168 may be used in combination with the positive displacement aerosol system 10b.

The dry station 136 (FIG. 7) functions to dry the substrates or slides 130 after they have passed through the washing process. Preferably, the substrates 130 are dried by heated or room temperature convection drying with air directed at the upper or exposed surfaces of the substrates 130. This is accomplished by providing the dry station 136 with an air blower 170, preferably mounted on a motion system, and having a nozzle 172 to blow heated or room temperature air on the surfaces of the substrates or glass slides 130.

Alternatively, or in addition, conduction heating, radiative infra-red (IR) heating or spin-dry techniques may be efficaciously used to dry the surfaces of the substrates 130, as required or desired, giving due consideration to the goals of accelerating, optimizing or otherwise enhancing the development of the microarray assay, and/or of achieving one or more of the benefits and advantages as taught or suggested herein. Optionally, one or more of the aerosol dispensers of the system may be used to blow air on the substrate surfaces to provide convection drying.

The probe addition station 138 (FIG. 7) performs the function of uniformly applying a coating of tagged sample reagent, along with a control reagent, if needed or desired, to the substrates or slides 130. Thus, after the dry process, this prepares the microarrayed DNA, proteins or other chemical or biological reagents on the substrates 130 for the hybridization or binding process. The probe reagent is preferably dispensed in the form of an aerosol mist to provide a quantitative and programmable delivery of reagent per unit area of each substrate or glass slide 130.

In one preferred embodiment, the probe addition station 138 comprises a positive displacement aerosol system 10c including an aerosol dispenser 12c, as discussed above and shown in FIGS. 2-5 (like reference numerals refer to like elements). Also as discussed above, the dispenser 12c is preferably mounted on a X, X-Y or X-Y-Z motion head or robotic system. Thus, multiple passes of the dispenser 12c may be performed over one or more of the substrates or glass slides 130, as needed or desired, to dispense a programmed or predetermined volumetric amount of the reagent on each substrate or slide 130. Advantageously, this reduces or minimizes the wastage of valuable reagent.

In one preferred embodiment, the aerosol system 10c aspirates probe reagent from a source such as a microwell of a microtiter plate and sprays or dispenses it onto one or more substrates or slides 130. Several different probe reagents may be applied to the substrates or slides 130, for example, a different probe reagent for each substrate or slide 130. In this case, one or more carriers such as 96, 384 or 1536 well microtiter plates are provided and hold different probe reagents in different microwells. The tip of the dispenser 12c is preferably washed in a wash workstation 61′, as discussed above for the dispenser 12, each time a different probe reagent is aspirated.

Alternatively, most of the system 10c may be filled with a probe reagent (as opposed to system liquid), particularly in the case when large volumes of the same probe reagent are to be dispensed. The probe addition station 138 can also utilize other suitable aerosol dispense systems such as positive displacement systems described in U.S. Pat. Nos. 5,738,728 and 5,916,524 to Tisone, the entire disclosure of each one of which is hereby incorporated by reference herein.

The concentration of the probe reagent can be varied to optimize the hybridization or binding, as needed or desired, depending on the particular application. Typically, each slide or substrate 130 receives about 1 microliter (μL) to about 5 microliter (μL) of probe reagent, though more or less can be efficaciously applied to the substrates 130, as needed or desired.

The incubation or heating station 140 (FIG. 7) heats the substrates or slides 130 along a portion or portions of the conveyor track. The heating facilitates in speeding up the reaction kinetics or hybridization or binding processes between the microarrayed reagent(s) on the substrates or slides 130 and the probe reagent(s) applied to the surfaces of the substrates or slides 130.

Preferably, the substrates 130 are heated by convection using heated air directed at the upper or exposed surfaces of the substrates 130. This is accomplished by providing the incubation station 140 with an air blower 180, preferably mounted on a motion system, and having a nozzle 182 to blow heated air on the surfaces of the substrates or glass slides 130. Alternatively, or in addition, the incubation station 140 comprises a radiation heat source such as an infra-red (IR) lamp 176 or the like to heat the substrates or slides 130. Alternatively, or in addition, the incubation station 140 comprises a heater 178 mounted on a stationary portion of the conveyor 122 to heat the substrates or slides 130 by conduction.

Alternatively, or in addition, a pick-and-place system may be used to heat the substrates or slides 130 off-line by convection, IR radiation, conduction or spin-drying techniques with efficacy, as required or desired, giving due consideration to the goals of accelerating, optimizing or otherwise enhancing the development of the microarray assay, and/or of achieving one or more of the benefits and advantages as taught or suggested herein. If needed, the substrates 130 can be cooled during the hybridization or binding process, or during or in-between any of the processes associated with the development and assaying of microarrays as discussed herein.

The wash station 142 (FIG. 7) performs the function of uniformly applying a coating of washing solution or reagent to the substrates or slides 130. Thus, after the hybridization or binding and incubation processes, this removes any excess probe reagents on the substrates or slides 130 and leaves only attached, hybridized or bound probes. The washing reagent is preferably dispensed in the form of an aerosol mist to provide a quantitative and programmable delivery of washing reagent per unit area of each substrate or glass slide 130.

In one preferred embodiment, the wash station 142 comprises a positive displacement aerosol system 10d including an aerosol dispenser 12d, as discussed above and shown in FIGS. 2-5 (like reference numerals refer to like elements). Also as discussed above, the dispenser 12d is preferably mounted on a X, X-Y or X-Y-Z motion head or robotic system. Thus, multiple passes of the dispenser 12d may be performed over one or more of the substrates or glass slides 130, as needed or desired, to dispense a programmed or predetermined volumetric amount of the washing reagent on each substrate or slide 130. Advantageously, this reduces or minimizes the wastage of valuable reagent.

The dispenser 12d may aspirate washing reagent from a source and then dispense it on the substrates or glass slides 130, as needed. Alternatively, most of the system 10d may be filled with a washing reagent (as opposed to system liquid), particularly in the case when large volumes of the same washing reagent are to be dispensed. The wash station 142 can also utilize other suitable aerosol dispense systems such as positive displacement systems described in U.S. Pat. Nos. 5,738,728 and 5,916,524 to Tisone, the entire disclosure of each one of which is hereby incorporated by reference herein.

In one preferred embodiment, the wash station 142 comprises a pick-and-place system 184 to pick substrates or slides 130 from the conveyor track and dip them offline in a bath containing washing solution or reagent. If desired, the pick-and-place system 184 may be used in combination with the positive displacement aerosol system 10d.

The dry station 144 (FIG. 7) functions to dry the substrates or slides 130 after they have passed through the prior washing process. Preferably, the substrates 130 are dried by heated or room temperature convection drying with air directed at the upper or exposed surfaces of the substrates 130. This is accomplished by providing the dry station 144 with an air blower 186, preferably mounted on a motion system, and having a nozzle 188 to blow heated or room temperature air on the surfaces of the substrates or glass slides 130.

Alternatively, or in addition, conduction heating, radiative infra-red (IR) heating or spin-dry techniques may be efficaciously used to dry the surfaces of the substrates 130, as required or desired, giving due consideration to the goals of accelerating, optimizing or otherwise enhancing the development of the microarray assay, and/or of achieving one or more of the benefits and advantages as taught or suggested herein. Optionally, one or more of the aerosol dispensers of the system may be used to blow air on the substrate surfaces to provide convection drying.

The hybridized, bound or linked readable microarrays on the substrates or slides 130 are fed to the detection and analysis system 126 utilizing a feeder or pick-and-place system 190 or the like. When a dye, such as Cy3 and Cy5 dyes, is used as the detection tag, the tagged probe reagent provides a reader signal when excited by a light source. The detection system preferably comprises a confocal laser scanner or CCD camera 192 or other suitable detector to scan the substrates 130 for hybridized or bound sites and a computer 194 and associated software is used to analyze the data. A movable table or platform can be incorporated into the system 126 to facilitate transport of the substrates 130 during analysis.

Any one of a number of suitable detection tags may be used with the probe reagent. These include dyes such as Cy3 and Cy5, optically active molecules, optical readable particles such as gold and latex among other, magnetic readable particles, radioactive molecules or particles, other fluorescent and chemiluminescent labels, and bioactive labels such as derived from living tissue.

Any one of a number of suitable pick-and-place systems, feeder systems, stackers, carriers, X, X-Y, X-Y-Z or rotary motion providing tables, carriages or platforms and the like can be efficaciously used in conjunction with the in-line processing system to move, pick or place selected components or associated components of the system, as needed or desired, to optimize process efficiency, and/or of achieving one or more of the benefits and advantages as taught or suggested herein.

Advantageously, the above assay development processes coupled with motion provide uniformity in application of the reagents over the surfaces of the substrates 130, and also a high degree in repeatability in preparing the substrates or slides 130. Additionally, and desirably, the process configuration enhances or improves quantitation or volumetric precision due to the accurate quantitative dispensing of reagents on the surfaces of the substrates or slides 130, and also due to the inherent symmetry and repeatability of a continuous process configuration.

Another advantage is provided by spraying the block, wash, probe and any other associated reagents in the form of an aerosol mist comprising small droplets (in the picoliter range and up to about 100 nanoliters or more). This is particularly important for the probe/substrate reaction during hybridization, binding or linking. The small droplet sizes generated with an aerosol device enhance or speed up the reaction kinetics to achieve faster process times, especially compared to conventional bulk dispensing of reagents on substrates. One reason for the enhanced reaction rate is due to the momentum transfer of the droplets and the coalescence of the aerosol reagents on the substrate surface being exothermic reactions. This advantageously generates heat to enhance the reaction kinetics. Moreover, surface diffusion dominates the reaction kinetics. Desirably, the surface diffusion provides reaction kinetics which are about one to four orders of magnitude faster than bulk diffusion.

The enhanced reaction kinetics also advantageously allow a short incubation period for hybridization or binding. This increases the overall efficiency in assaying and processing microarrays. Typically, the incubation or heating period is in the range of minutes or less. Moreover, and advantageously, the enhanced reaction kinetics may allow the incubation or heating process to be eliminated, and hence the hybridization or binding reactions take place at room or ambient temperature, without the application of heat. Conventional hybridization processes typically have an incubation or heating period which is undesirably in the range of hours.

The in-line microarray assaying system 100 or selected sections of the system 100 can be enclosed in controlled environment enclosures for equipment control of humidity, temperature or other ambient conditions. For example, the humidity during probe addition and incubation processes can be maintained around 80% for evaporation control.

Preferably, a feedback control system is used to monitor and control the various components, operations and programmable processes of the in-line processing system 100. Vision sensors, readers or other sensors are preferably used for in-line inspection and control feedback for any of the microarray development and/or associated processes. For example, the signal to noise ratio during the hybridization process or development or reading of the microarray can be optimized with the fastest process time.

Optionally, ink jet dispensers may be used in place of one or more of the aerosol dispensers 12a, 12b, 12c or 12d. Preferred ink jet dispensers utilizing a solenoid actuated dispenser in series with a positive displacement pump are disclosed in U.S. Pat. Nos. 5,741,554, 5,743,960 and 5,916,524 to Tisone and U.S. Pat. No. 6,063,339 to Tisone et al., the entire disclosure of each one of which is hereby incorporated by reference herein. As the skilled artisan will recognize, other dispensing technologies as known in the art such as piezoelectric dispensers, fluid impulse dispensers, heat actuated dispensers and the like may also be efficaciously utilized, as needed or desired.

The mobility of the dispensers 12a, 12b, 12c and 12d and other associated processing equipment desirably allows random access and flexibility in positioning the dispensers and drying and heating equipment at different positions along the conveyor track. For example, the dispenser 12b may perform a wash in place of the downstream dispenser 12d, thereby eliminating its need and reducing cost. Moreover, a single dispenser may be used to dispense blocking, wash and probe reagents, if desired. Optionally, multiple dispensers may be operated serially (individually or sequentially) or in parallel (simultaneously or substantially simultaneously or synchronously) or a combination thereof along the conveyor track. Fewer or more processing stations 124 may be utilized depending on the particular application and/or the processing “recipe.”

If desired, more than one conveyor may be incorporated into the in-line processing system of the invention. A single processing station, for example, the wash station 134, may be used to service more than one of the conveyor tracks. Additionally, substrates 130 may be arranged in rows along the conveyor track and transported in the indexing direction 166 to be processed at downstream processing stations.

Batch Processing of Microarrays

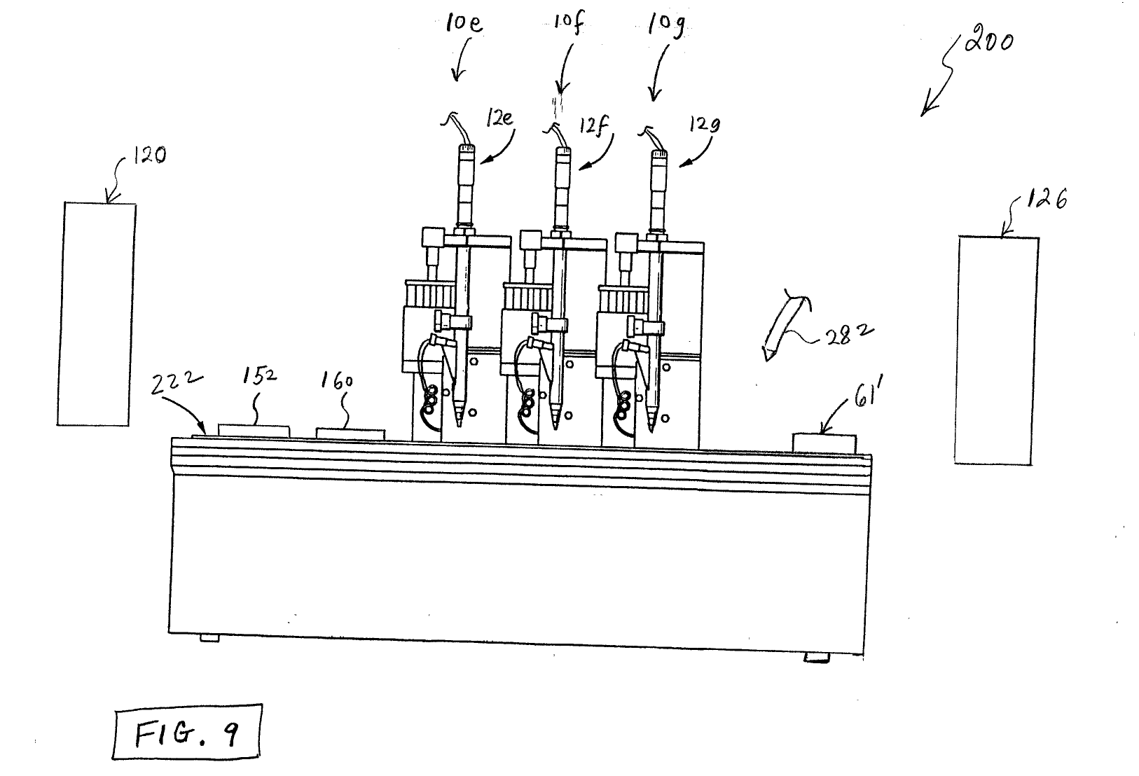

FIG. 9 is a schematic view of a batch microarray processing system 200 having features and advantages in accordance with one preferred embodiment of the present invention. Advantageously, the batch system 200 provides inexpensive, quantitative and high throughput processing of microarrays of DNA, proteins and other biological or chemical reagents. This is preferably based on process steps which are performed serially to an array of microarray slides or substrates mounted on a movable table or carriage.

The batch configuration captures most of the benefits of the in-line approach, as described above. Thus, for purposes of clarity and brevity of disclosure only certain features, operations and advantages of the batch processing system 200 are discussed herein below and it is to be understood that other features, operations and advantages are evident and/or embodied in the description as set forth above.

The batch processing system 200 advantageously processes between about 200 to about 2000 or more high density microarrays, substrates or glass slides per day. In other words, the batch processing system 200 advantageously processes between about 35 to about 350 or more high density microarrays, substrates or glass slides per hour. This has application in a high throughput setting such as a clinical laboratory environment. Conventional technologies as presently practiced can only process tens of such microarrays per day.

The batch microarray processing system 200 generally comprises a spotting or microarraying machine or workstation 120, one or more aerosol dispensing systems or workstations 10e, 10f, 10g respectively comprising one or more aerosol dispensers 12e, 12f, 12g, as discussed above and shown in FIGS. 2-5 (like reference numerals refer to like elements), an X, X-Y or X-Y-Z motion platform or table 222, a wash workstation 61′ and a detection and analysis workstation 126.

The dispensers 21e, 12f and 12g are movable via X, X-Y or X-Y-Z motion heads, as discussed above. The platform 222 transports the array of substrates 130 seated thereon, as needed, and various microarray processing and assaying operations are performed, as has been discussed above.

The system 200 further comprises a source of reagent(s) or liquid(s) such as one or more microtiter plates 152 and a tooling plate 160 comprising a plurality of nests 158 and holding a plurality of substrates or glass slides 130 (see FIG. 8) preferably arranged in an array and having microarrays formed thereon.

Though several dispensing systems 10e, 10f, 10g are shown in FIG. 9, in one preferred embodiment, a single dispensing system, for example, system 10e is sufficient. In this embodiment, the dispenser 12e is used to dispense blocking, wash and probe reagents onto the substrates 130 in a serial (individual or sequential) mode of operation by combining dispensing with motion control. The reagents are aspirated from the microtiter plate(s) 152. The tip of the dispenser 12e is cleaned in the wash station 61′, as necessary.

Preferably, the aerosol dispenser 12e is also used to dry the substrates 130, as necessary, by blowing air, thereby displacing some of the wash reagent off the substrates 130 but not onto adjacent substrates. Alternatively, or in addition, an air nozzle 282 is provided to blow air to dry the substrates 130, as needed.

The tooling plate 160 is preferably adaptable to tilt the substrates 130 so that any excess wash or blocking reagents are drained into a collection trough or drain. This can be accomplished in several ways, for example, by selectively controlling the tilting of the tooling plate 160 using a spring-loaded plunger actuated by a solenoid or the like, among others.

Preferably, the tooling plate 160 and/or the nests 158 can be heated or cooled to heat or cool the substrates 130, as needed, for example during hybridization and incubation processes. This can be accomplished by providing heaters mounted on the tooling plate 160 and/or the nests 158.

In one preferred embodiment, the batch processing system 200 is operated in a parallel mode by simultaneously or substantially simultaneously or synchronously operating a plurality of aerosol dispensers, such as dispensers 12e, 12f and 12g, combined with motion control to perform the various processes involved in developing the microarrays. Optionally, a plurality of dispensers may be used to perform various processes in an in-line manner at different positions as the platform 222 transports or moves the array of substrates 130.

In one preferred embodiment, the batch and in-line techniques may be combined. For example, the wash and dry processes may be performed using a batch processing scheme while the probe addition and incubation processes may utilize an inline approach, as described above. Many variations and combinations are contemplated by the present invention, such as combinations of in-line processing schemes, batch processing schemes, serial processing, parallel processing, among others.

As discussed above, the enhanced reaction kinetics allows a short incubation period for hybridization or binding. This increases the overall efficiency in assaying and processing microarrays. Typically, the incubation or heating period is in the range of minutes or less. Moreover, and advantageously, the enhanced reaction kinetics may allow the incubation or heating process to be eliminated, and hence the hybridization or binding reactions take place at room or ambient temperature, without the application of heat. Conventional hybridization processes typically have an incubation or heating period which is undesirably in the range of hours.

The skilled artisan will realize that there are many different “recipes” for processing, assaying and developing reagent microarrays. Some of these involve, several treatments with reagents and several heating and drying steps, as needed. Thus, the preferred embodiments of the present invention can efficaciously utilize fewer or more dispensing systems or processing stations, as required or desired, giving due consideration to the goals of achieving high throughput, and/or of achieving one or more of the benefits and advantages as taught or suggested herein.

Universal Substrate/Slide Cassette

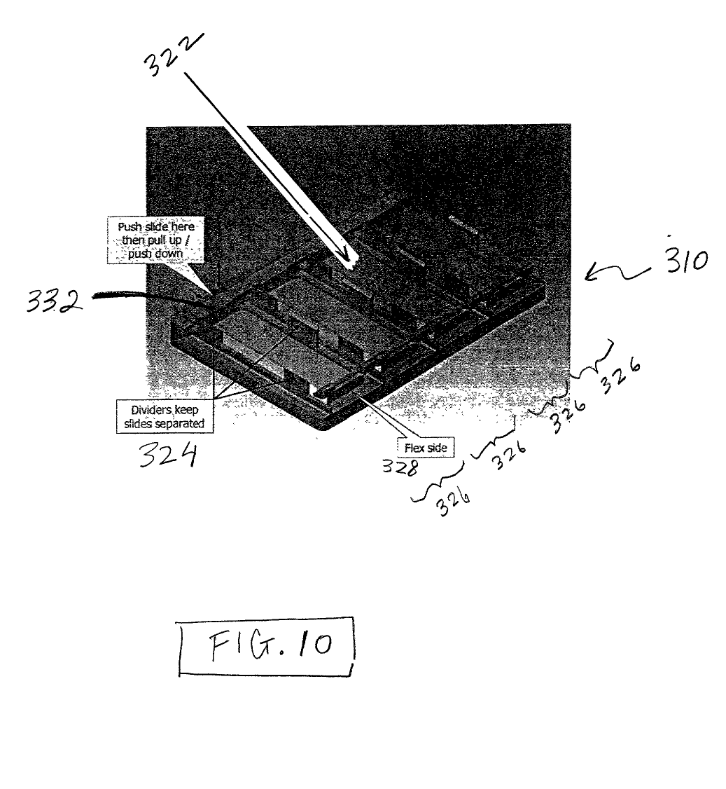

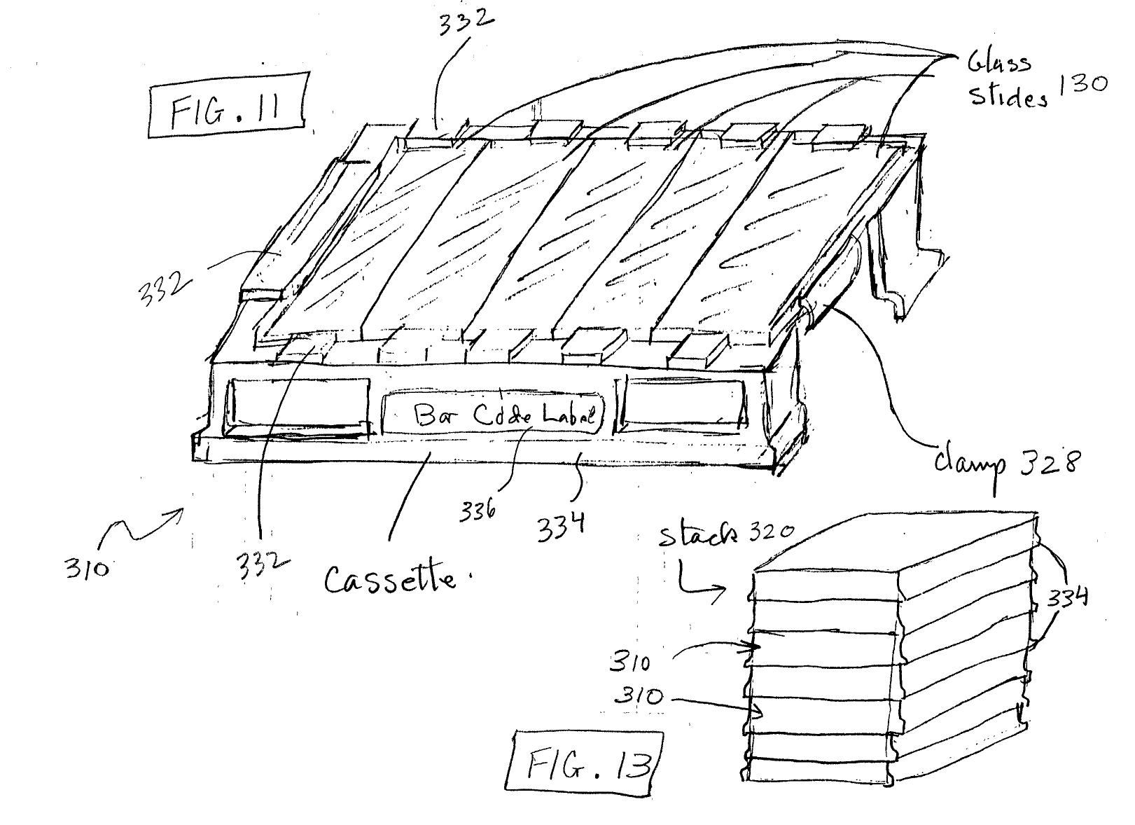

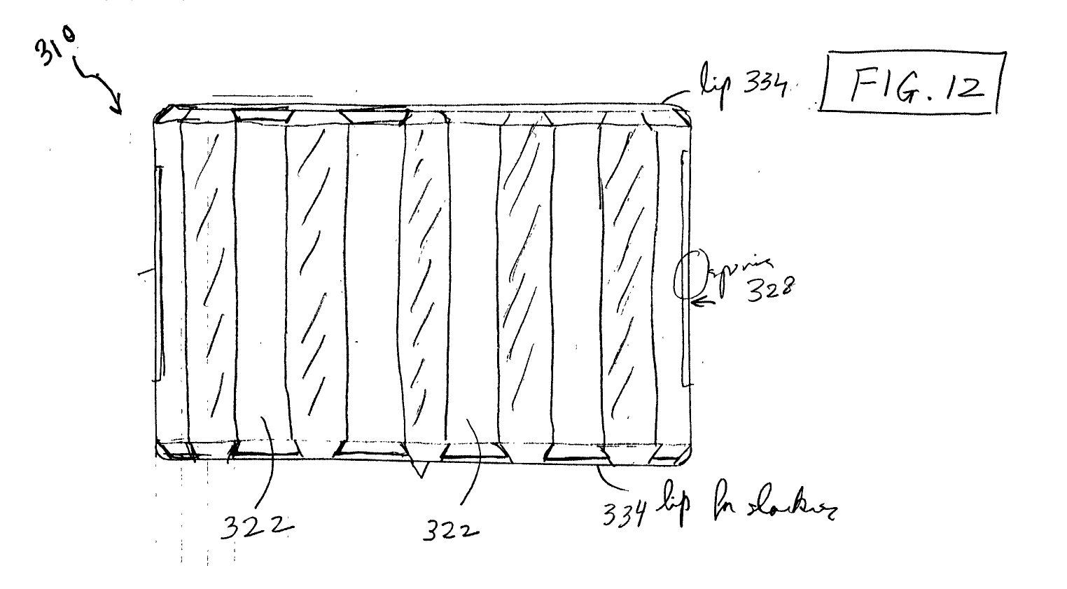

FIG. 10 is a simplified perspective view of a multiple substrate holding cassette 310 having features and advantages in accordance with one preferred embodiment of the present invention. Other preferred embodiments are shown in FIGS. 11 and 12, and a stack 320 of cassettes 310 is shown in FIG. 13. Advantageously, the use of a cassette 310 to carry multiple substrates facilitates high throughput, thereby increasing process efficiency.

The cassette or carrier is designed to hold a plurality of substrates or glass slides 130 through a number of processes steps, such as described above, without the need to remove the substrates or slides 130. Advantageously, this optimally minimizes or eliminates the handling of individual parts or substrates 130 between operations or process steps.

For example, the steps would include (i) loading the substrates 130 in the cassette 310, (ii) dispensing microarrays on each of the substrates 130, (iii) washing and drying the substrates 130, (iv) applying probe reagents or other chemistries to the substrates 130 with incubation (heat and time), (v) washing and drying the substrates 130, (vi) reading the hybridized or bound microarrays on the substrates 130, and (vii) storing the substrates 130.

In one preferred embodiment, the cassette has a size and shape substantially the same as that of a standard microtiter plate to process glass slides. Typically, the cassette 310 would hold four to five smaller glass slides or one larger glass slide. In one preferred embodiment, the cassette of the present invention holds five microscope (25 mm×76 mm) glass slides or one larger microwell plate size (116 mm×76 mm) glass slide. The cassette 310 is preferably functional without all the substrates 130 loaded, that is, for example, the cassette 310 can be used with only three substrates 30 even if it can accommodate five substrates.

Advantageously, the cassette 310 allows processing of the substrates 130 from the beginning to the end of a sequence of processes, for example, arraying to reading of the processed microarrays, as described above. Conventional technologies handle each substrate individually which is labor intensive and prone to error.

Preferably, the cassette 310, which holds multiple substrates 130 during a series of processes, comprises a generally rigid and planar structure with through holes or slots 322 such that the substrates 130 can be accessed on either side, that is, top and bottom. In one preferred embodiment, the substrates 130 are seated in a plurality of compartments or nests 326, comprising the cavities 322, and are separated by dividers 324 (FIG. 10). The nest design desirably provides finger holes which facilitates in loading of the slides or substrates 130 in the cassette 310. In another preferred embodiment, the substrates 130 (FIG. 11) are in contact with or abut against adjacent substrates or glass slides.

The nest design or cavities or through holes 322 advantageously provide an open structure for easy removal of wash and blocking solutions or reagents. This can also provide for more uniform heating and/or cooling of the substrates 130 when loaded in the cassette 310. Moreover, and desirably, the nest design or cavities or through holes 322 reduces the weight of the cassette 310. This advantageously facilitates the handling of the substrate-loaded cassettes 310 during the various process steps and also reduces the overall weight in a stacked configuration such as the stack 320. The height of the cassette 310 may also be optimally minimized to reduce weight.

One or more clamps, springs, snaps, grippers, spring clips or flexible members 328 are provided to hold the substrates 130 in place. The clamps or spring grippers 328 are preferably easy to open and close for convenient loading and/or unloading of slides or substrates 130. Moreover, the clamps 328 are adapted to be easily replaced, as needed or desired.

In one preferred embodiment, and referring to FIG. 10, a clamp 328 is provided at an end of each of the compartments 328. Each substrate 130 is pushed or inserted at an opposite end, pulled up and then pulled down to seat the substrate in the cassette 310. The opposite end preferably has an edge 332 which extends over the substrate 130 to further facilitate in keeping it seated in place.

In another preferred embodiment, and referring to FIG. 11, a clamp 328 is provided at one end of the cassette 310 to hold an adjacent substrate 130, and thereby the plurality of substrates 130 which are in contact with or abut against adjacent substrates. Inwardly extending edges 332 may be provided to further facilitate in seating the substrates 130 in place. Additionally, reference edges or grooves and the like can be provided to position the slides.

Preferably, the cassette 310 comprises one or more lips 334 which facilitate stacking of the cassettes 310. The lips 334 serve as an alignment mechanism between adjacent cassettes 310 of the stack 320. Alternatively, or in addition, the lips 334 serve as an alignment mechanism for stacking the cassettes 310 in a stacker, processing magazine and the like.

The cassette 10 preferably has a readable bar code 336 or the like on the side of the cassette 310 to identify and keep track of the cassettes and the substrates thereon. In one preferred embodiment, the coding is replaceable such as a label or the like. In another preferred embodiment, the coding is programmable such as a chip or the like.

A plurality of cassettes 310 are used as part of a process for fabricating and analyzing microarrays on the surfaces of the substrates or slides 130. Thus, the cassettes 310 will pass through a series of workstations, as described above. Each cassette 310 preferably comprises alignment features for alignment with the various components of the processing equipment, for example, the arraying machine 120. These alignment features can comprise alignment pins, receptacles, indexing slots or holes and the like formed on the sides or body of the cassette 310. The cassette 310 preferably has other capture features to attach to various equipment components, for example, such as to be mountable or attachable on the conveyor 122.

The cassette 310 is preferably configured such that there is an optimally minimal capture area to reduce residual reagent and carryover. Moreover, the cassette 310 is preferably configured so that it is light weight. This advantageously facilitates the handling of the substrate-loaded cassettes 310 during the various process steps and also reduces the overall weight in a stacked configuration such as the stack 320.

One advantage of the preferred embodiments of the cassette 310 is that it allows batch processing of the substrates 310 and this provides for higher throughput. Another advantage of the cassette 310 is that it serves as a universal holder to be used through a series of steps, that is, arraying, washing, drying, hybridization, reading and even storage.

The cassette 310 can be used in conjunction with automated in-line and batch processing techniques which are described above. For the in-line conveyor-based system the cassette 310 can also serve as the processed palette.

Another advantage of the cassette 310 is that it permits arraying on both sides of the substrates or slides 130, that is, the upper and lower surfaces. This adds to the versatility and utility of the invention. The cassette 310 also advantageously serves to protect the substrates 130, and thereby reduces losses due to damaged or broken substrates or slides 130. Moreover, the substrates or slides 130 can be pre-packaged on cassettes 310 by a supplier and hence shipped to a customer for immediate use. This can save cost for both the supplier and customer. In one preferred embodiment, the cassette 310 is configured such that it has an industry standard microwell plate outline which advantageously allows the cassette to be compatible with of standard microwell plate handling equipment.

In one preferred embodiment, the cassette 310 has a length of about 127 mm, a width of about 85 mm and a height of about 15 mm. In other preferred embodiments, the cassette 310 may be efficaciously dimensioned and configured in alternate manners, as required or desired, giving due consideration to the goals of providing a suitably strong, compact and light weight cassette, and/or of achieving one or more of the benefits and advantages as taught or suggested herein.

In one preferred embodiment, the cassette 310 has a weight of about 114 grams (4 ounces). In other preferred embodiments, the cassette 310 may be efficaciously configured to weigh less or more, as required or desired, giving due consideration to the goals of providing a suitably strong, compact and light weight cassette, and/or of achieving one or more of the benefits and advantages as taught or suggested herein.

In one preferred embodiment, the cassette 310 is fabricated from anodized aluminum. In other preferred embodiments, the cassette 310 may be efficaciously formed from other metals, alloys, ceramics and plastics, as needed or desired, giving due consideration to the goals of providing a suitably strong, compact and light weight cassette, and/or of achieving one or more of the benefits and advantages as taught or suggested herein.

In one preferred embodiment, the cassette 310 is formed by extruding and machining. In another preferred embodiment, the cassette 310 is formed by molding. In other preferred embodiments, the cassette 310 may be efficaciously formed by casting or forging among other techniques, as needed or desired, giving due consideration to the goals of providing a suitably strong cassette, and/or of achieving one or more of the benefits and advantages as taught or suggested herein.

While the components and techniques of the present invention have been described with a certain degree of particularity, it is manifest that many changes may be made in the specific designs, constructions and methodology hereinabove described without departing from the spirit and scope of this disclosure. It should be understood that the invention is not limited to the embodiments set forth herein for purposes of exemplification, but is to be defined only by a fair reading of the appended claims, including the full range of equivalency to which each element thereof is entitled.

What is claimed is:

1. A method of high throughput and quantitative processing of microarrays of biological or chemical material on substrates, comprising the steps of:
simultaneously transporting a plurality of said substrates at a predetermined speed on a movable surface;
dispensing at least one tagged reagent onto said substrates in the form of an aerosol mist; and
incubating said substrates under conditions that promote reaction between said tagged reagent and said biological or chemical material while said substrates are on said movable surface.

2. The method of claim 1, wherein said step of simultaneously transporting a plurality of said substrates comprises the step of transporting said substrates on a conveyor.

3. The method of claim 1, wherein said step of simultaneously transporting a plurality of said substrates comprises the step of transporting said substrates on a platform.

4. The method of claim 1, comprising the further step of forming said microarrays on said substrates prior to said simultaneously transporting step.

5. The method of claim 4, wherein the microarrays are DNA microarrays.

6. The method of claim 4, wherein the microarrays are protein microarrays.

7. The method of claim 1, comprising the further step of dispensing a blocking reagent on said substrates in the form of an aerosol mist.

8. The method of claim 1, comprising the further step of dispensing a wash reagent on said substrates in the form of an aerosol mist.

9. The method of claim 1, comprising the further step of blowing air on said substrates to dry said substrates.

10. The method of claim 1, comprising the further step of analyzing said substrates using a laser after said step of incubating said substrates.

11. An apparatus for in-line processing of high density microarrays of DNA material on a plurality of substrates, comprising:
a conveyor for providing continuous indexing motion to said substrates while a series of assaying processes are performed at predetermined positions along said conveyor;
a plurality of workstations, each of said workstations adapted to perform at least one of said assaying processes;
a fluid transfer device positioned at a predetermined position along said conveyor, comprising:
a dispenser mounted on a motion head and adapted to aspirate programmable volumetric amounts of reagents from a source and to dispense programmable volumetric amounts of said reagents in the form of a spray on said substrates to uniformly coat said substrates;
a positive displacement pump serially connected to said dispenser for metering the aspiration and dispensing of said reagents; and
a heating system positioned at a predetermined position along said conveyor and downstream of said fluid transfer device for incubating said substrates as they are transported on said conveyor.

12. The apparatus of claim 11, wherein said conveyor comprises a walking beam conveyor.

13. The apparatus of claim 11, wherein said positive displacement pump comprises a syringe pump.

14. The apparatus of claim 11, wherein said heating system comprises a blower to convectively incubate said substrates.

15. The apparatus of claim 11, wherein said heating system comprises an infrared (IR) lamp to radiatively incubate said substrates.

16. The apparatus of claim 11, wherein said heating system comprises a heater to conductively incubate said substrates.

17. The apparatus of claim 11, further comprising an arraying machine for forming said microarrays on said substrates.

18. A system for the batch processing of arrays of biological or chemical material, comprising:
a plurality of substrates with each substrate having an array of said biological or chemical material thereon;
a motion platform having an array of said substrates housed thereon; and
a dispenser mounted on an X, X-Y or X-Y-Z robotic head for serially dispensing predetermined quantities of reagents on said substrates and comprising a first passage for dispensing reagents onto said substrates and a second passage for blowing air on said substrates to dry said substrates.

19. The system of claim 18, wherein said biological material comprises DNA.

20. The system of claim 18, wherein said biological material comprises proteins.

21. The system of claim 18, further comprising a direct current fluid source hydraulically coupled to said dispenser to meter precise dispensing of said reagents from said dispenser.

22. The system of claim 18, further comprising a positive displacement pump hydraulically coupled to said dispenser to meter precise dispensing of said reagents from said dispenser.

23. The system of claim 18, further comprising a plurality of said dispensers for parallelly dispensing predetermined quantities of reagents on said substrates.

24. An apparatus for transferring a liquid from a source to a target, comprising:
an aspirate-dispense device, comprising:
a first passage having an orifice at one end for aspirating liquid into said first passage and dispensing said liquid from said first passage;
a second passage adapted for the flow of pressurized air for mixing with said liquid dispensed from said first passage to form an aerosol mist; and
a miniaturized tip formed at said orifice and insertable in receptacles for aspirating said liquid to be transferred; and
a positive displacement pump in fluid communication with said first passage for metering predetermined quantities of said liquid into and out of said orifice.

25. The apparatus of claim 24, wherein said tip has an outer diameter between about 500 μm and about 2000 μm.

26. The apparatus of claim 24, wherein said tip has an inner diameter between about 50 μm and about 250 μm.

27. The apparatus of claim 24, wherein said tip has a length between about 1 mm to about 10 mm.

28. The apparatus of claim 24, wherein said tip is formed from a ceramic.

29. The apparatus of claim 24, wherein said tip is formed from alumina.

30. A method of transferring a liquid from a source to a target using an aspirate-dispense device having a first passage connected to a metering pump and a second passage connected to a pressurized air reservoir, said first passage having a tip at one end, said method comprising the steps of:
inserting said tip of said device in said liquid in said source;
aspirating a predetermined quantity of said liquid into said first passage of said device by operating said pump;
positioning said tip of said device over said target; and
dispensing a predetermined quantity of said liquid onto or into said target in the form of an aerosol mist by operating said pump and mixing said liquid with air flow from said reservoir.

31. A carrier for holding a plurality of slides through a series of assaying processes, comprising:
a plurality of nests with each said nest being sized and configured to receive one of said slides;
a plurality of clamps for securing said slides in said nests, each said clamp being positioned at an end of each said nest; and
each said nest comprising a through cavity such that when said slides are loaded in said nests, the upper and lower surfaces of said slides are exposed for forming and processing of microarrays of biological or chemical material thereon.

32. The carrier of claim 31, further comprising a lip to facilitate in aligning a stack of said carriers.

33. The carrier of claim 31, further comprising a readable code to identify said carrier.

34. The carrier of claim 31, wherein said carrier comprises anodized aluminum.

35. The carrier of claim 31, wherein said carrier has a footprint of about 127 mm×85 mm.

36. A method of transporting a plurality of substrates in a cassette through a series of workstations, each of said workstations adapted to form or process biological or chemical microarrays on said substrates, said method comprising the steps of:
seating said substrates in a plurality of compartments formed in said cassette, each said compartment having a through hole so that the upper and lower surfaces of said substrates are accessible for forming or processing said microarrays thereon;
securing said substrates in said compartments using a plurality of clamps, each said clamp being positioned at an end of each said compartment; and
transporting said substrates in said cassette through said workstations by one or more movable surfaces.
